(19) United States
(12) Patent Application Publication
(10) Pub. No.: US 2026/0051540 A1
(43) Pub. Date: Feb. 19, 2026

(54) ELECTROLYTE COMPOSITIONS INCLUDING QUATERNARY AMMONIUM COMPOUNDS FOR SECONDARY BATTERIES

(71) Applicants: Georgia Tech Research Corporation, Atlanta, GA (US); LG Energy Solution, Ltd., Seoul (KR)

(72) Inventors: Seung Woo Lee, Atlanta, GA (US); Kyungbin Lee, Atlanta, GA (US); Kun Ryu, Atlanta, GA (US); Soohyun Kim, Daejeon (KR); Dayoung Kim, Daejeon (KR)

(73) Assignees: Georgia Tech Research Corporation, Atlanta, GA (US); LG Energy Solution, Ltd., Seoul (KR)

(21) Appl. No.: 19/301,205

(22) Filed: Aug. 15, 2025

Related U.S. Application Data
(60) Provisional application No. 63/683,964, filed on Aug. 16, 2024.

(51) Int. Cl. H01M 10/0567; H01M 10/0525; H01M 10/0568; H01M 10/0569; H01M 50/609

(52) U.S. Cl. CPC H01M 10/0567; H01M 10/0525; H01M 10/0568; H01M 10/0569; H01M 50/609; H01M 2220/20; H01M 2300/0028

(57) ABSTRACT

Disclosed is an electrolyte composition, a secondary battery comprising the electrolyte composition, and a method of preparing a secondary battery. The electrolyte composition includes an electrolyte compound, a quaternary ammonium fluoride-containing compound, and a solvent.

### CROSS-REFERENCE TO RELATED APPLICATIONS

This application claims priority to U.S. Provisional Application No. 63/683,964, filed Aug. 16, 2024. The contents of the prior application are hereby incorporated by reference in their entirety.

### FIELD OF TECHNOLOGY

The present disclosure relates to an electrolyte composition, a secondary battery comprising the electrolyte composition, and a method of preparing a secondary battery. In particular, the disclosure relates to an electrolyte composition comprising an electrolyte compound, a quaternary ammonium fluoride-containing compound, and a solvent.

### BACKGROUND

There continues to be an increase in electrified transportation, exemplified by the widespread adoption of electric vehicles (EVs) and the emergence of urban air mobility (UAM) vehicles. Simultaneously, there is a growing demand for stationary energy storage systems, notably in the residential and industrial sectors, powered by solar and wind generators. This shift is driven in part by the pressing need to mitigate the adverse environmental and climate impacts associated with traditional internal combustion engines and other non-renewable means of power generation. Thus, the development of battery technologies with high energy density, while also ensuring enhanced safety, has become an imperative.

Lithium-ion batteries are critical to the advancement of electrified transportation and energy storage systems, and have had a significant and positive impact on green energy and climate change mitigation efforts. While such conventional lithium-ion batteries are superior to many other energy sources, lithium-ion batteries, and particularly liquid lithium-ion batteries, also have certain limitations. For example, various safety mechanisms are critical for lithium-ion batteries to restrict voltage and internal pressures, but these safety features typically result in increased weight and performance limitations in certain instances. Moreover, lithium-ion batteries are susceptible to aging, leading to capacity loss and eventually failure after a number of years of use.

Recently, there has been a growing number of studies exploring the application of modified solvent structures to be applied in electrolyte solutions for lithium-ion batteries. And quaternary ammonium compounds have been considered as functional additives in electrolyte solutions. However, this field remains underexplored. Most conventional studies have focused on the effects of quaternary ammonium compounds themselves, while systematic studies assessing the electrochemical performance of various electrolyte solutions in lithium-ion batteries are still lacking. And, despite advancements, electrolyte systems with modified solvent structures suffer from inferior ionic conductivity, manufacturing complexity, and high associated costs, limiting their practicality in commercial secondary batteries.

There is still a need to secure technology to develop novel electrolyte compositions to enhance Li reversibility and enable high-voltage secondary battery operation, while addressing practical concerns regarding energy density, cycle life, and cost. Therefore, continuous efforts are conducted to develop electrolyte solutions having improved battery performance and stability compared to conventional lithium-ion batteries.

### SUMMARY

Disclosed aspects may solve these and other problems associated with conventional lithium-ion batteries by using electrolyte compositions including quaternary ammonium compounds, such as quaternary ammonium fluoride-containing compounds (e.g., tetrabutylammonium tetrafluoroborate), as a functional additive to an electrolyte. Tetrabutylammonium tetrafluoroborate (TBATFB), in particular, includes a bulky tetrabutylammonium cation (TBA+) and a tetrafluoroborate anion (TBA−). Without intending to be bound by theory, it is believed that, when added to the electrolyte, the bulky tetrabutylammonium cation and the tetrafluoroborate anion work synergistically to suppress dendrites growth, enhance interfacial stability, and improve cycle life and efficiency. The electrolyte compositions according to aspects were found to form a stable passivating film or interface without tailoring the electrolyte solvation structure. It is believed that the bulky tetrabutylammonium cation inhibits dendrite growth by regulating Li flux, while the tetrafluoroborate anion fluorinates the anode without changing its metallic lattice structure. This synergy results in compact and uniform electrodeposition characterized by high reversibility, facilitated by the stable solid electrolyte interface (SEI). The enhanced SEI interface also enables compatibility with 4-V class cathodes, overcoming the thermodynamic limitations of traditional ether electrolytes dominated by solvent-separated ion pairs (SSIPs).

The inventors found that by controlling the content of constituent elements in the electrolyte compositions and optimizing constituent concentrations by adjusting the concentration of the quaternary ammonium compound and the electrolyte compatibility between the electrolyte composition and the anode could be reliably and efficiently achieved. In this manner, the electrolyte compositions may be specifically designed to optimize Li reversibility and ion transport properties, while enhancing the cycle stability of high-energy secondary batteries by integrating dendrite and corrosion suppression mechanisms. Moreover, the electrolyte compositions according to aspects present a notable economic advantage compared to other conventional electrolytes, while delivering comparable electrochemical performances and improving the anodic and cathodic interfacial stability.

In one aspect, there is provided an electrolyte composition for a secondary battery. The electrolyte composition comprises an electrolyte compound, a quaternary ammonium fluoride-containing compound, and a solvent.

The solvent may comprise an ether compound. The ether compound may comprise at least one selected from the group consisting of tetrahydrofuran (THF), ethylene carbonate (EC), diethyl ether (DEE), 1,3-dioxolane (DOL), 1,2-dimethoxyethane (DME), cyclohexyl ether, tetraethylene glycol dimethyl ether (TEGDME), 1,1,2,2-tetrafluorethyl 2,2,3,3-tetrafluoropropylether (TTTE), fluorinated 1,6-dimethoxyhexane (FDMH), 1,2-bis(2,2-difluoroethoxy)-ethane (F4DEE), 2-methyltetrahydrofuran, dimethyl tetrahydrofuran, dimethoxytetrahydrofuran, ethoxytetrahydrofuran, dihydropyran, tetrahydropyran, furan, and 2-methylfuran. The ether compound may comprise tetrahydrofuran (THF).

The electrolyte compound may comprise at least one selected from the group consisting of lithium bis(fluorosulfonyl)imide (LiFSI), lithium bis(trifluoromethanesulfonyl)imide (LTFSI), LiPF₆, LiAsF₆, LiBF₄, LiCF₃SO₃, and LiCliO₄. The electrolyte compound may comprise lithium bis(fluorosulfonyl)imide (LiFSI).

The quaternary ammonium fluoride-containing compound may comprise tetrabutylammonium tetrafluoroborate (TBATFB).

The electrolyte compound and the quaternary ammonium fluoride-containing compound may be comprised in the electrolyte composition at a molar ratio in a range of 10:0.01 to 0.1:5.

The electrolyte compound and the quaternary ammonium fluoride-containing compound may be comprised in the electrolyte composition at a molar ratio in a range of 1:0.1 to 1:1.

In another aspect, there is provided an secondary battery comprising the electrolyte composition described above.

In another aspect, there is provided a secondary battery a positive electrode, a negative electrode, and an electrolyte composition comprising lithium bis(fluorosulfonyl)imide (LiFSI), tetrabutylammonium tetrafluoroborate (TBATFB), and tetrahydrofuran (THF).

The lithium bis(fluorosulfonyl)imide (LiFSI) and the tetrabutylammonium tetrafluoroborate (TBATFB) may be comprised in the electrolyte composition at a molar ratio in a range of 1:0.1 to 1:1.

The secondary battery may have a columbic efficiency of greater than 95% over at least 200 cycles.

The secondary battery may have a specific capacity of greater than 100 mAh/g for at least 100 cycles at a charge/discharge rate in a range of C/5 to 1C.

The secondary battery may have a capacity retention of greater than 90% for at least 500 cycles at a charge/discharge rate in a range of C/5 to 1C.

The positive electrode may be configured to intercalate Li+ ions or Na+ ions.

In another aspect, there is provided an electric vehicle comprising the secondary battery described above.

In another aspect, there is provided a method of preparing a secondary battery. The method comprises, the method comprising forming an electrode assembly comprising a positive electrode and a negative electrode, and injecting into the electrode assembly an electrolyte composition comprising an electrolyte compound, a quaternary ammonium fluoride-containing compound, and a solvent.

The electrolyte compound and the quaternary ammonium fluoride-containing compound may be comprised in the electrolyte composition at a molar ratio in a range of 10:0.01 to 0.1:5.

The electrolyte compound may comprise lithium bis(fluorosulfonyl)imide (LiFSI), the quaternary ammonium fluoride-containing compound may comprise tetrabutylammonium tetrafluoroborate (TBATFB), and the solvent may comprise tetrahydrofuran (THF).

Each aspect may further have one or more additional elements in any combination.

### BRIEF DESCRIPTION OF THE DRAWINGS

The accompanying drawings illustrate aspects of the present disclosure, and together with the detailed disclosure, serve to provide a further understanding of the technical aspects of the present disclosure, and the present disclosure should not be construed as being limiting to the drawings. In the drawings, for clarity of description, the shape, size, scale or proportion of the elements may be exaggerated for emphasis.

FIGS. 1A and 1B are schematics illustrating the interactions between the electrolyte, 4-V class cathode, and Li metal anode (LMA) when utilizing conventional ether electrolyte (FIG. 1A) and an electrolyte solution according to disclosed aspects (FIG. 1B).

FIG. 2 is a schematic illustrating snapshots of solvated Li₊ as it progresses towards Li metal anode (a) without TBA₊ cation layer, and (b) with TBA₊ cation layer.

FIG. 3 is a schematic illustrating AIMD simulations of the solvent and salt decomposition process (a) without TBATFB and (b) with TBATFB.

FIG. 4 is a schematic illustrating AIMD simulations of (a) THF, (b) BF₄₋, and (c) FSI₋ decomposition process over 50 ps.

FIG. 5 shows a comparison of the theoretical and experimental investigation of electrolyte solutions according to disclosed aspects compared to a conventional electrolyte: (a) THF adsorption energy against metallic Li and ions within the electrolyte. Snapshots obtained from MD simulations of (b) conventional electrolyte and (c) electrolyte solution according to disclosed aspects, and (d) their corresponding Li⁺ radial distribution function. (e) Raman spectra obtained from pure THF, conventional electrolyte, and electrolyte solution according to disclosed aspects. (f) ⁷Li, (g) ¹⁹F, and (h) ¹⁷O nuclear magnetic resonance (NMR) spectra of conventional electrolyte and electrolyte solution according to disclosed aspects.

FIG. 6 illustrates the electrostatic potential of BF₄₋, FSI₋, and TBA₊ ions calculated using density functional theory (DFT).

FIG. 7 shows Li plating/stripping CEs for Li∥Cu asymmetric cells at 1 mA cm⁻² and 1 mAh cm⁻².

FIG. 8 shows Li plating/stripping protocol for Li∥Cu asymmetric cells at 0.5 mA cm⁻² and 5 mAh cm⁻².

FIG. 9 shows Li plating/stripping CEs for the Li∥Cu asymmetric cell using a high-concentration electrolyte of 3 M LiFSI in THF at 1 mA cm⁻² and 1 mAh cm⁻².

FIG. 10 shows nucleation overpotential profiles of different electrolytes at current density of 1 mA cm⁻².

FIG. 11 shows ionic conductivity measurements of different electrolytes.

FIG. 12 shows viscosity of different electrolytes measured as a function of TBATFB concentration in 1M LiFSI in THF.

FIG. 13 shows nyquist plots of Li∥Li symmetric cells before and after polarization of 10 mV.

FIG. 14 shows steady state current measurement of Li∥Li symmetric cells under 10 mV for 2 hours.

FIG. 15 shows passivation leakage current measurement of Li∥Cu cells at 0 V vs. Li/Li+ for 10 hours.

FIG. 16 shows a Tafel plot of Li∥Li symmetric cells measured between −0.2 and 0.2 V vs. Li/Li₊ under scan rate of 0.5 mV s⁻¹.

FIG. 17 shows overpotentials of galvanostatic charge/discharge cycles under low currents, ranging from 20 to 100 μA.

FIG. 18 shows voltage profiles of galvanostatic charge/discharge under low currents, ranging from 20 to 100 μA.

FIG. 19 shows an integrated plot for determining the optimized additive concentration by comparing the following categories: exchange current density, passivation current, coulombic efficiency, ionic conductivity, Li⁺ transference number, and nucleation overpotential.

FIG. 20 shows Raman spectra of pure THF, CEE, ACE, and high-concentration electrolyte (HCE, 3 M LiFSI in THF). HCE was added to show a clear difference between the free FSI/THF and coordinated FSI/THF.

FIG. 21 shows electrochemical performance, stability, and characterization of LMA. (a) CEs of Li plating/stripping for Li∥Cu asymmetric cells at 3 mA cm⁻² and 3 mAh cm⁻². (b) Second cycle CEs with varying calendar ageing times. Cycling stability of Li∥Li symmetric cells under (c) 10 mA cm⁻² and 4 mAh cm⁻² and (d) 20 mA cm⁻² and 20 mAh cm⁻². SEM images showing surface morphology and cross-sectional views of LMA cycled in (e) CEE and (f) ACE. (g) Energies of Li[THF]ₙ⁺, where n represents the coordination number. (h) Potential energy diagram of Li[THF]₄⁺ calculated using the NEB method at different reaction coordinates.

FIG. 22 shows voltage profiles of the second plating and stripping profiles for (a,c,e) CEE and (b,d,f) ACE. Cells were either (a,b) not rested, (c,d) rested for a day, (e,f) or rested for 5 days.

FIG. 23 shows cycling stability of Li∥Li symmetric cells at 1 mA cm⁻² and 1 mAh cm⁻².

FIG. 24 shows EIS of Li∥Li symmetric cells before and after 100 cycles. (a) CEE and (b) ACE electrolytes were used to cycle Li∥Li symmetric cells for 100 cycles at 1 mA cm⁻² and 1 mAh cm⁻².

FIG. 25 shows SEI chemical composition. XPS characterization of cycled LMA. (a) Atomic composition ratios at different sputtering times using CEE and ACE. (b) C 1s, (c) F 1s, (d) O 1s, (e) Li 1s, and (f) S 2p spectra of CEE- and ACE-cycled LMAs. XPS spectra were displayed on columns, with each heigh corresponding to depth profiling results.

FIG. 26 shows (a) rate performance of the LFP cathode and (b and c) corresponding voltage profiles.

FIG. 27 shows (a) Rate performance of the LFP cathode and (b and c) corresponding voltage profiles. (d) Cycling performance of the LFP cathode at 0.8 mA cm⁻².

FIG. 28 shows (a) Long-cycling performance of Li∥LFP cells and (b and c) corresponding voltage profiles. Conditions: the 35 μm LMA paired with the 4 mAh cm⁻² LFP cathode, with N/P ratio of 1.75 and E/C ratio of 15 g Ah⁻¹.

FIG. 29 shows (a) Cycling performance of Li∥LFP cells under practical conditions and (b and c) corresponding voltage profiles. Conditions: the 35 μm LMA paired with the 4 mAh cm⁻² LFP cathode, with N/P ratio of 1.75 and E/C ratio of 5 g Ah⁻¹.

FIG. 30 shows electrochemical floating test of Li∥NCA88 cells at 4.3 V vs. Li/Li⁺ for 20 hours.

FIG. 31 shows capacity of the NCA88 cathodes (2 mAh cm⁻²) cycled at 1 C.

FIG. 32 shows EIS profiles of the cycled NCA88 cathodes.

FIG. 33 shows voltage-time profiles of GITT of cycled Li∥NCA88 cells using CEE and ACE. Ohmic and non-ohmic voltage loss measured from GITT profiles as a function of discharge capacity.

FIG. 34 shows differential capacity as a function of voltage (dQ dV⁻¹ vs. V) of Li∥NCA88 measured between 3.0 and 4.3 V.

FIG. 35 shows transmission electron microscopy images and Fourier transform of the NCA88 cathodes cycled in (a) CEE and (b) ACE. Scale bar 5 nm.

FIG. 36 shows atomic composition ratios at different sputtering times using (a) CEE and (b) ACE.

FIG. 37 shows XPS characterization of cycled NCA88. (a) C 1s and (b) O 1s spectra of CEE- and ACE-cycled NCA88 are displayed on columns, with each heigh corresponding to depth profiling results.

FIG. 38 shows (a) rate performance of the NCA88 cathode and (b and c) corresponding voltage profiles.

FIG. 39 shows fuel-cell performance with designed electrolyte. (a) Long-cycling performance of Li∥NCA88 cells replicated three times. Conditions: 50 μm LMA paired with 2 mAh cm⁻² NCA88 cathode, with N/P ratio of 5.0 and E/C ratio of 4.0 g Ah⁻¹. The cells cycled at 0.5 C charge and discharge. (b) Cycling performance of Li∥NCA88 cells under practical conditions. Conditions: 35 μm LMA paired with 4 mAh cm⁻² NCA88 cathode, with N/P ratio of 1.75 and E/C ratio of 5.1 g Ah⁻¹. The cells cycled at 0.1 C charge and ⅓ C discharge. (c) Cycling performance of anode-free Cu∥NCA-88 cells. Conditions: Cu paired with 2 mAh cm⁻² cathode, with E/C ratio of 4.0 g Ah⁻¹. (d) Comparison of cycle number, cycle retention, current density, and practicality factor with LMB performance with other ether electrolytes. Practicality factor is defined as the product of the N/P ratio and E/C ratio. Comparison of (e) Li∥Cu Coulombic efficiencies and respective areal capacities and (f) Li∥4-V class cathode cycle number, capacity retention, and E/C ratio plotted against the electrolyte cost for different electrolyte design strategies.

FIG. 40 shows voltage profiles of long-term cycling of Li∥NCA88 cells using (a) CEE and (b) ACE. Conditions: 50 μm LMA paired with 2 mAh cm⁻² NCA88 cathode, with N/P ratio of 5.0 and E/C ratio of 10.2 g Ah⁻¹.

FIG. 41 shows CE of Li∥NCA88 cycling performances. Conditions: 50 μm LMA paired with 2 mAh cm⁻² NCA88 cathode, with N/P ratio of 5.0 and E/C ratio of 10.2 g Ah⁻¹.

FIG. 42 shows voltage polarization of Li∥NCA88 cycling performances. Conditions: the 50 μm LMA paired with the 2 mAh cm⁻² NCA88 cathode, with N/P ratio of 5.0 and E/C ratio of 10.2 g Ah⁻¹.

FIG. 43 shows voltage profiles of long-term cycling of Li∥NCA88 cells using (a) CEE and (b) ACE. Conditions: the 35 μm LMA paired with the 4 mAh cm⁻² NCA88 cathode, with N/P ratio of 1.75 and E/C ratio of 5.1 g Ah⁻¹.

FIG. 44 shows CE of Cu∥NCA88 cycling performances. Conditions: Cu paired with the 2 mAh cm⁻² NCA88 cathode, with E/C ratio of 5.1 g Ah⁻¹.

FIG. 45 shows voltage profiles of Cu∥NCA88 cycling performances. Conditions: Cu paired with the 2 mAh cm⁻² NCA88 cathode, with E/C ratio of 5.1 g Ah⁻¹.

FIG. 46 shows ionic conductivity of baseline, 0.1 M, 0.5 M, and 1.0 M TBATFB electrolytes. Electrochemical impedance spectroscopy (EIS) was measured at open-circuit voltage in the frequency range of 10-1 Hz to 105 Hz with an 19 amplitude of 10 mV.

FIG. 47 shows Nyquist plots of Li∥Li symmetric cells before and after polarization of 10 mV for 2 hours for (a) baseline (b) 0.1 M TBATFB, (c) 0.5 M TBATFB, and (d) 1.0 M TBATFB electrolytes. EIS was measured at open-circuit voltage in the frequency range of 10-1 Hz to 105 Hz with an amplitude of 10 mV. Inset: Steady-state current measurement under 10 mV polarization for 2 hours.

FIG. 48 shows (a) Coulombic efficiencies for asymmetric Li∥Cu cells at current density and areal capacity of 1 mA cm⁻² and 1 mAh cm⁻². (b) Coulombic efficiency of Aurbarch protocol with reservoir capacity of 5 mAh cm⁻², followed by 10 cycles at 0.5 mA cm⁻² and 0.5 mAh cm⁻² before full stripping.

FIG. 49 shows a passivation stability test of Li∥Cu asymmetric cell with voltage hold at 0.0 V vs. Li/Li+ for 10 hours. Inset: Leakage current between 9 and 10 hours of voltage hold.

FIG. 50 shows a floating test of Li∥LiNi_{0.88}Co_{0.09}Al_{0.03}O₂ at a 4.3 V vs. Li/Li+ for 20 hours.

FIG. 51 shows Areal capacity and coulombic efficiency of Li∥NCA-88 full cells under practical conditions (35 μm Li anode, 20 mg cm⁻² NCA-88 cathode, N/P ratio of 1.75 and E/C ratio of 5 g Ah⁻¹).

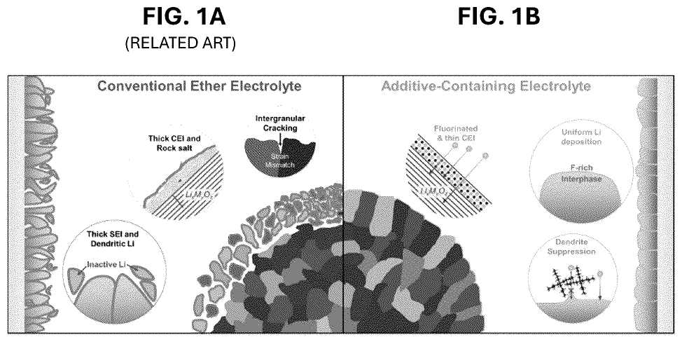

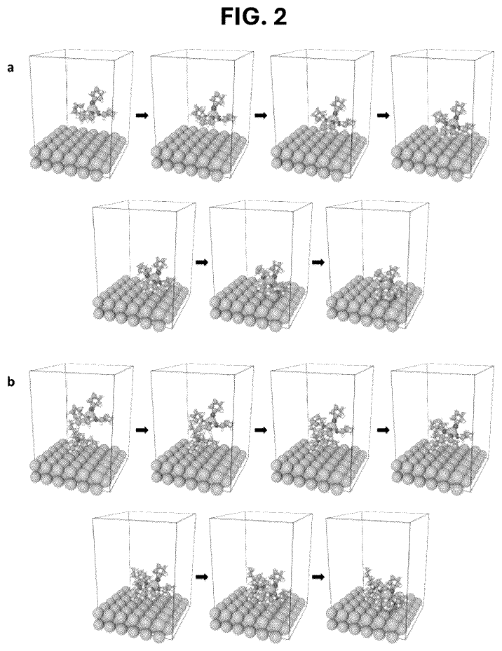

### DETAILED DESCRIPTION

Hereinafter, the present disclosure will be described in detail. It should be understood that the terms or words used in the specification and the appended claims should not be construed as limited to general and dictionary meanings, but rather interpreted based on the meanings and concepts corresponding to the technical aspects of the present disclosure on the basis of the principle that the inventor is allowed to define terms appropriately for the best explanation. Therefore, the aspects of the disclosure described herein and the elements shown in the drawings are just aspects of the present disclosure, but not intended to fully describe the technical aspects of the present disclosure, so it should be understood that other equivalents and modifications could have been made thereto at the time the application was filed. Unless defined otherwise, all the technical and scientific terms used herein have the same meanings as commonly known by a person skilled in the art. In the case that there is a plurality of definitions for the terms herein, the definitions provided herein will prevail.

Unless specified otherwise, all the percentages, portions and ratios in the present disclosure are on weight basis.

Unless indicated to the contrary, the numerical parameters set forth in the following specification and attached claims are approximations that may vary depending upon the desired properties sought to be obtained according to aspects of the disclosure. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values.

While compositions and methods are described herein in terms of “comprising” various components or steps, the compositions and methods may also “consist essentially of” or “consist of” the various components and steps. The term “comprise(s)” or “include(s)” when used in this specification, specifies the presence of stated elements, but does not preclude the presence or addition of one or more other elements, unless the context clearly indicates otherwise.

The terms “about” and “substantially” are used herein in the sense of at, or nearly at, when given the manufacturing and material tolerances inherent in the stated circumstances and are used to prevent the unscrupulous infringer from unfairly taking advantage of the present disclosure where exact or absolute figures are stated as an aid to understanding the present disclosure. The terms “about” and “approximate”, when used along with a numerical variable, generally means the value of the variable and all the values of the variable within an experimental error (e.g., 95% confidence interval for the mean) or within a specified value±10% or within a broader range. Unless otherwise indicated, all numbers expressing quantities of ingredients, properties such as molecular weight, reaction conditions, and so forth used in the present specification and associated claims are to be understood may be modified by the term “about.”

“A and/or B” when used in this specification, specifies “either A or B or both.”

As used herein, the term “average particle size” means average obtained particle size as observed using scanning electron microscopy (SEM).

As used herein, the term “mean particle size” means mean particle size as observed using SEM.

The terms “cathode” and “positive electrode” may be used interchangeably herein.

The terms “anode” and “negative electrode” may be used interchangeably herein.

### <Secondary Battery>

The present disclosure relates to a secondary battery comprising a positive electrode, a negative electrode, and an electrolyte composition. Specific examples of the secondary battery include any type of primary battery, secondary battery, fuel cell, solar cell or capacitor such as a super capacitor. In aspects, the secondary battery may be a lithium-ion or a sodium ion secondary battery. Aspects of the disclosure herein may be implemented in a secondary battery with various form factors or battery formats, including for example in a pouch-type battery, a cylindrical battery, or a prismatic battery.

In aspects, the positive electrode comprises a positive electrode current collector and a positive electrode active material layer on a surface of the positive electrode current collector facing the solid electrolyte layer. The positive electrode active material layer may be disposed on or present as a coating layer on at least one side of the positive electrode current collector. The battery may further comprise a separator between the positive electrode and the negative electrode.

In aspects, the negative electrode may comprise a negative electrode current collector and a negative electrode active material layer on a surface of the negative electrode current collector. The negative electrode active material layer may be disposed on or present as a coating layer on at least one side of the negative electrode current collector.

In some aspects, the battery may comprise the negative electrode comprising a negative electrode active material layer without a current collector. The negative electrode may consist of only the negative electrode active material layer. The negative electrode may exclude an independent current collector.

The secondary battery according to aspects may endure charging and discharging cycles up to a current density as high as 1.0 mA/cm², 2.0 mA/cm², 2.5 mA/cm², 3.0 mA/cm², 4.0 mA/cm², 5.0 mA/cm², or even 10.0 mA/cm².

The secondary battery according to aspects may have a coulombic efficiency of 20%, 30%, 40%, 50%, 60%, 70%, 80%, 85%, 90%, 95%, 96%, 97%, 98%, 99%, 99.9%, or 99.99% or more, after 10, 20, 30, 40, 50, 100, 500, 1,000, 1,500, 1,600, 1,700, 1,800, 1,900, 2,000, 2,100, 2,200, 2,300, 2,400, 2,500, 3,000, 3,500, 4,000, 4,500, or 5,000 or more charge cycles.

### <Electrolyte Composition>

The electrolyte composition according to aspects may include an electrolyte compound and an additive compound. The electrolyte composition may be in the form of a liquid or a solid. In some aspects, the electrolyte composition is a liquid electrolyte with at least one of the electrolyte compound and the additive compound being provided in a solvent.

The presence of the electrolyte compound and the additive compound is an important feature of disclosed aspects. These compounds may be added to or present in the electrolyte composition in liquid or solid form, or in the form of their respective salts.

The additive compound may be a fluorine-containing compound including, but not limited to, a quaternary ammonium fluoride-containing compound. This fluorinating mechanism suppresses dendrite formation and supports stable high-current and high-capacity operations. Without intending to be bound by theory, it is believed that this additive compound forms a robust interface with enhanced charge transport kinetics, enabling compatibility with cathodes. In some aspects, the quaternary ammonium fluoride-containing compound may be tetrabutylammonium tetrafluoroborate (TBATFB).

The additive compound may be included in the electrolyte composition in any suitable amount. For example, the additive compound may be included in the electrolyte composition in 0.1% to 99.9%, 1% to 99%, 5% to 95%, 10% to 90%, 20% to 80%, 30% to 70%, 40% to 60%, or 45% 5o 55% by weight or volume based on total weight or volume of the electrolyte composition

The electrolyte compound may be any suitable electrolyte or its salt. For example, the electrolyte compound may include, but is not limited to, at least one selected from the group consisting of lithium bis(fluorosulfonyl)imide (LiFSI), lithium bis(trifluoromethanesulfonyl)imide (LTFSI), LiPF₆, LiAsF₆, LiBF₄, LiCF₃SO₃, and/or LiCliO₄. In some aspects, the electrolyte compound may be lithium bis(fluorosulfonyl)imide (LiFSI).

The electrolyte compound may be included in the electrolyte composition in any suitable amount. For example, the electrolyte compound may be included in the electrolyte composition in 0.1% to 99.9%, 1% to 99%, 5% to 95%, 10% to 90%, 20% to 80%, 30% to 70%, 40% to 60%, or 45% 5o 55% by weight or volume based on total weight or volume of the electrolyte composition.

The solvent may be any suitable organic or inorganic solvent. In aspects, the solvent may be an ether solvent including, but not limited to, tetrahydrofuran (THF), ethylene carbonate (EC), diethyl ether (DEE), 1,3-dioxolane (DOL), 1,2-dimethoxyethane (DME), cyclohexyl ether, tetraethylene glycol dimethyl ether (TEGDME), 1,1,2,2-tetrafluorethyl 2,2,3,3-tetrafluoropropylether (TTTE), fluorinated 1,6-dimethoxyhexane (FDMH), 1,2-bis(2,2-difluoroethoxy)-ethane (F4DEE), 2-methyltetrahydrofuran, dimethyl tetrahydrofuran, dimethoxytetrahydrofuran, ethoxytetrahydrofuran, dihydropyran, tetrahydropyran, furan, and/or 2-methylfuran. In some aspects, the ether compound may be tetrahydrofuran (THF).

The respective concentrations of the electrolyte compound and the additive compound in the electrolyte composition is also an important feature in disclosed aspects. The electrolyte compound and the additive compound may be included in the electrolyte composition at a molar ratio in a range of 100:0.001 to 0.01:50, 10:0.01 to 0.1:5, 5:0.5 to 1.5:0.1, or 1:0.1 to 1:1. In some aspects, the optimal relative molar concentration of the electrolyte compound and the additive compound in the electrolyte composition is 1:0.1.

By optimizing the concentrations of the electrolyte compound and the additive compound in the electrolyte composition, it is possible to strengthen electrode-electrolyte interfaces by incorporating the ionic additive TBATFB into a low-concentration THF ether electrolyte. Without intending to be bound by theory, it is believed that the TBF anions minimize corrosion and Li inventory loss, while the bulky TBA+ cations adsorb onto the anode surface and enable uniform and compact electrodeposition.

### <Current Collectors>

The positive electrode current collector and negative electrode current collector are not particularly limited as long as they are conductive without causing any chemical change in the secondary battery, and for example, copper, stainless steel, aluminum, nickel, titanium, sintered carbon, copper or stainless steel whose surface is treated with carbon, nickel, titanium, silver or the like, or aluminum-cadmium alloy, etc., may be used. In aspects, the current collectors may be copper. Additionally, the current collectors may include various forms such as a film, a sheet, a foil, a net, a porous body, a foam, and a nonwoven fabric having minute irregularities formed on their surfaces.

### <Positive Electrode>

The positive electrode according to aspects may include any suitable materials so long as the positive electrode is capable of carrying suitable intercalating ions such as, for example, Li⁺ and Na⁺. For purposes of this disclosure, lithium ions will be described. However, it will be understood that the disclosure is not intended to be so limited and that sodium-ions are contemplated in addition or as an alternative to lithium ions.

In the positive electrode, a positive electrode current collector may be used, and is not particularly restricted, as long as the positive electrode current collector exhibits high conductivity while the positive electrode current collector does not induce any chemical change in the battery to which the positive electrode current collector is applied. For example, the positive electrode current collector may be made of stainless steel, aluminum, nickel, titanium, or plastic carbon. Alternatively, the positive electrode current collector may be made of aluminum or stainless steel, the surface of which is treated with carbon, nickel, titanium, or silver.

The positive electrode current collector is not limited to a particular type and may include those having high conductivity without causing a chemical change in the corresponding battery, for example, stainless steel, copper, aluminum, nickel, titanium, sintered carbon, or aluminum or stainless steel treated with carbon, nickel, titanium and silver on the surface.

Some aspects relate to wherein the cathode positive electrode further comprises a positive electrode material, a solid electrolyte and a conductive agent. In some aspects, the positive electrode material comprises a lithium nickel manganese cobalt oxide (hereinafter referred to as NMC, Li-NMC, LNMC, or NCM), which are mixed metal oxides of lithium, nickel, manganese and cobalt with the general formula LiNiₓMn_{y}Co_{1-x-y}O₂. In some aspects, the positive electrode material comprises at least one of LiCoO₂, LiMn₂O₄, LiMnO₂, or LiNiO₂. In some aspects, the positive electrode material comprises sulfur.

In some aspects of the present disclosure, the positive electrode active material may comprise at least one of lithium cobalt oxide (LiCoO₂), lithium nickel oxide (LiNiO₂), lithium manganese oxide of Formula Li₁₊ₓMn₂₋ₓO₄ (x is 0 to 0.33, for example LiMn₂O₄), LiMnO₃, LiMn₂O₃, LiMnO₂, lithium copper oxide (Li₂CuO₂); vanadium oxide such as LiV₃O₈, LiV₂O₄, V₂O₅, Cu₂V₂O₇, Ni-site lithium nickel oxide represented by Formula LiNi₁₋ₓMₓO₂ (M=Co, Mn, Al, Cu, Fe, Mg, B or Ga, 0<x<1), for example, LiNi_{1-z} (Co,Mn,Al)_{z}O₂ (0<z<1); lithium manganese composite oxide represented by Formula LiMn₂₋ₓMₓO₄ (M=Co, Ni, Fe, Cr, Zn or Ta, x=0.01˜1, for example, LiMn_{1.5}Ni_{0.5}O₄ or Li₂Mn₃MO₈ (M=Fe, Co, Ni, Cu or Zn); LiMn₂O₄ with partial substitution of alkali earth metal ion for Li in Formula; disulfide compounds; Fe₂(MoO₄)₃, or lithium iron phosphate (LiFePO₄). In some aspects of the present disclosure, the lithium iron phosphate may have all or at least part of the of the active material particle surface coated with a carbon material to improve conductivity.

According to aspects of the disclosure, the positive electrode active material may comprise at least one selected from Lithium Nickel Cobalt Manganese Oxide (for example, Li(Ni,Co,Mn)O₂, LiNi_{1-z}(Co,Mn,Al)_{z}O₂ (0<z<1)), Lithium Iron Phosphate (for example, LiFePO4/C), Lithium Nickel Manganese Spinel (for example, LiNi_{0.5}Mn_{1.5}O₄), Lithium Nickel Cobalt Aluminum Oxide (for example, Li(Ni,Co,Al)O₂), Lithium Manganese Oxide (for example, LiMn₂O₄) and Lithium Cobalt Oxide (for example, LiCoO₂).

According to some aspects of the present disclosure, the positive electrode active material may comprise lithium transition metal composite oxide, and the transition metal may comprise at least one of Co, Mn Ni or Al.

In some aspects of the present disclosure, the lithium transition metal composite oxide may comprise at least one of compounds represented by the following formula 1.

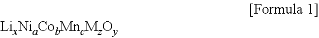

In the above Formula 1, 0.5≤x≤1.5, 0<a≤1, 0≤b<1, 0≤c<1, 0≤z<1, 1.5<y<5, a+b+c+z is 1 or less, and M may comprise at least one selected from Al, Cu, Fe, Mg and B.

In some aspects of the present disclosure, the positive electrode active material includes a positive electrode active material having high Ni content of a of 0.5 or more, and its specific example may comprise LiNi_{0.8}Co_{0.1}Mn_{0.1}O₂.

In some aspects of the present disclosure, the positive electrode conductive material may comprise, for example, at least one conductive material selected from the group consisting of graphite, carbon black, carbon fibers or metal fibers, metal powder, conductive whiskers, conductive metal oxide, activated carbon or polyphenylene derivatives. More specifically, the positive electrode conductive material may be at least one conductive material selected from the group consisting of natural graphite, artificial graphite, super-p, acetylene black, ketjen black, channel black, furnace black, lamp black, thermal black, denka black, aluminum powder, nickel powder, zinc oxide, potassium titanate and titanium oxide.

The positive electrode current collector is not limited to a particular type and may include those having high conductivity without causing a chemical change in the corresponding battery, for example, stainless steel, copper, aluminum, nickel, titanium, sintered carbon, or aluminum or stainless steel treated with carbon, nickel, titanium and silver on the surface.

The positive electrode binder resin may include polymer for electrode commonly used in the technical field. Non-limiting examples of the binder resin may include, but are not limited to, polyvinylidene difluoride, polyvinylidene fluoride-co-hexafluoropropylene, polyvinylidene fluoride-co-trichloroethylene, polymethylmethacrylate, polyethylhexyl acrylate, polybutylacrylate, polyacrylonitrile, polyvinylpyrrolidone, polyvinylacetate, polyethylene-co-vinyl acetate, polyethylene oxide, polyarylate, cellulose acetate, cellulose acetate butyrate, cellulose acetate propionate, cyanoethylpullulan, cyanoethylpolyvinylalcohol, cyanoethylcellulose, cyanoethylsucrose, pullulan and carboxyl methyl cellulose.

In some aspects of the present disclosure, the solid electrolyte included in the positive electrode may comprise at least one selected from a polymer-based solid electrolyte, an oxide-based solid electrolyte and a sulfide-containing solid electrolyte. In some aspects of the present disclosure, the positive electrode active material may comprise the sulfide-containing solid electrolyte described in the solid electrolyte membrane.

In some aspects of the present disclosure, the positive electrode active material is included in the positive electrode in an amount of 50 wt % or more based on 100 wt % of the positive electrode active material layer. Additionally, the solid electrolyte is, according to aspects of the disclosure, included in the positive electrode in an amount of 10 wt % to 40 wt % based on 100 wt % of the positive electrode active material layer.

### <Negative Electrode>

The negative electrode according to aspects is not particularly limited. The negative electrode may include a negative electrode active material that includes any suitable materials so long as the negative electrode is capable of carrying suitable intercalating ions from the positive electrode such as, for example, Li+ and Na+, as already described herein.

In some aspects, the negative electrode active material may include a carbon-containing active material, a silicon-containing active material, and/or a metal-containing active material capable of forming an alloy with lithium.

In the negative electrode, a negative electrode current collector may be used, and is not particularly restricted, as long as the negative electrode current collector exhibits high conductivity while the negative electrode current collector does not induce any chemical change in the battery to which the negative electrode current collector is applied. For example, the negative electrode current collector may be made of stainless steel, aluminum, nickel, titanium, or plastic carbon. Alternatively, the negative electrode current collector may be made of aluminum or stainless steel, the surface of which is treated with carbon, nickel, titanium, or silver.

The negative electrode current collector is not limited to a particular type and may include those having high conductivity without causing a chemical change in the corresponding battery, for example, stainless steel, copper, aluminum, nickel, titanium, sintered carbon, or aluminum or stainless steel treated with carbon, nickel, titanium and silver on the surface.

### <Method of Manufacturing Battery>

In aspects, the secondary may be prepared by a method of forming an electrode assembly comprising a positive electrode and a negative electrode. The method may include injecting into the electrode assembly an electrolyte composition comprising an electrolyte compound, a quaternary ammonium fluoride-containing compound, and a solvent. The electrolyte composition including the electrolyte compound, the quaternary ammonium fluoride-containing compound, and the solvent may each be as described herein.

In the present disclosure, the method of manufacturing the secondary battery may include mounting the assembled cell in a sheathing member, and then the sheathing member is encapsulated by heating and compression. A laminate case made of aluminum or stainless steel, a cylindrical metal container, or a prismatic metal container may be appropriately used as the sheathing member.

The respective electrode slurry may be coated on the corresponding current collector using a method of placing the electrode slurry on the current collector and uniformly dispersing the electrode slurry with a doctor blade, a die casting method, a comma coating method, or a screen-printing method. Alternatively, the electrode slurry and the current collector may be formed on a separate substrate, and the electrode slurry and the current collector may be joined to each other through pressing or lamination. At this time, the concentration of a slurry solution or the number of coatings may be adjusted in order to adjust the final coating thickness.

The drying process is a process of removing the solvent or moisture from the slurry in order to dry the slurry coated on the metal current collector. The drying process may vary depending on the solvent that is used. For example, the drying process may be performed in a vacuum oven having a temperature of 50° C. to 200° C. For example, drying may be performed using a warm-air drying method, a hot-air drying method, a low-humidity-air drying method, a vacuum drying method, a (far-) infrared drying method, or an electron beam radiation method. The drying time is not particularly restricted. In general, drying is performed within a range of 30 seconds to 24 hours.

After the drying process, a cooling process may be further performed. In the cooling process, slow cooling to room temperature may be performed such that the recrystallized structure of the binder is sufficiently formed.

In addition, if necessary, a rolling process, in which the electrode is passed through a gap between two heated rolls such that the electrode is compressed so as to have a desired thickness, may be performed in order to increase the capacity density of the electrode and to improve adhesion between the current collector and the active material after the drying process. In the present disclosure, the rolling process is not particularly restricted. A well-known rolling process, such as pressing, may be performed. For example, the electrode may pass through a gap between rotating rolls, or a flat press machine may be used to press the electrode.

### <Batteries Generally>

Batteries according to aspects may include lithium-ion batteries and/or sodium-ion batteries. For purposes of this disclosure, lithium-ion batteries will be described. However, it will be understood that the disclosure is not intended to be so limited and that sodium-ions are contemplated in addition or as an alternative to lithium ions.

### Lithium-Ion Batteries

A solid-state battery can receive a charge and discharge an electrical load at various times. A solid-state battery includes electrodes, a cathode electrode and an anode electrode, and an electrolyte to allow lithium ions to travel between the electrodes. In contrast to conventional liquid electrolyte batteries, the solid-state battery does not include any flowable liquids. Forming a circuit between the electrodes causes electricity to flow between the electrodes. During charging of the lithium-ion rechargeable battery, lithium ions are emitted from the cathode electrode and are intercalated into an active material of the anode electrode. During charging of the lithium-ion rechargeable battery, lithium ions are emitted from the anode electrode and are intercalated into an active material of the cathode electrode. As lithium ions reciprocate between the electrodes, they transfer energy.

### Solid State Battery Configuration

The present disclosure provides a solid-state battery comprising a cathode electrode, an anode electrode, and a solid electrolyte layer intermediate the cathode electrode and the anode electrode. In some aspects, the solid electrolyte may function as both an electrolyte and a separator. While listed as exemplary, the solid-state battery does not require all of these components. For example, in some configurations, such as in an anodeless system, the anode electrode may be omitted. Alternatively, according to aspects of the disclosure, the anode electrode may comprise an anode material with a metal carbon composite, such as a silver-carbon blend or composite, where silver particles are complexed between amorphous and/or crystalline carbon particles. While silver is used as exemplary, other metals may be used, including for example, tin, silicon, zinc, or combinations thereof.

The solid-state battery can optionally comprise an additional layer or layers, such as, for example, a separator layer, a protective layer, an inhibitor layer, a solid electrolyte interface layer, or a combination thereof. For example, a protective layer may be incorporated between the electrodes and the solid electrolyte layer. This protective layer may comprise materials such as lithium phosphate, lithium titanate, or lithium lanthanum zirconium oxide (LLZO), which can help prevent undesirable side reactions at the electrode-electrolyte interface. The protective layer may also serve to mitigate dendrite formation, particularly on the anode side, thereby improving the overall cycle life and safety of the battery. A separator layer may also be included in some configurations of the solid-state battery. While traditional liquid electrolyte batteries often use porous polymer separators, solid state batteries may employ thin ceramic or glass-ceramic layers as separators. These separator layers can provide additional mechanical support to the battery structure while still allowing for efficient ion transport. Materials such as LLZO, LATP (lithium aluminum titanium phosphate), or LAGP (lithium aluminum germanium phosphate) may be used for this purpose. The separator layer may also be designed to have a gradient structure, with properties optimized for contact with both the cathode and anode materials.

### Cell Configuration

The solid-state battery may comprise a single cell. In other aspects, the solid-state battery can comprise multiple cells, such as, at least two cells, at least three cells, or at least four cells. Connecting the cells in series increases a voltage of the solid-state battery and connecting the cells in parallel increases an amp-hour capacity of the solid-state battery. In some aspects, the solid-state battery may be configured with a combination of series and parallel connections to achieve desired voltage and capacity characteristics. For example, multiple cells may be arranged in groups, with cells within each group connected in parallel to increase capacity, and these groups then connected in series to increase voltage. This configuration, sometimes referred to as a series-parallel arrangement, allows for greater flexibility in battery design and can help optimize performance for specific applications. Additionally, the number and arrangement of cells may be adjusted to meet various form factor requirements.

### Thickness of Cell

A thickness, t₁, of the cell can be about 100, 150, 200, 250, 300, 400, 500, 1,000 μm, 2,000 μm, or 5,000 μm. In some aspects, the thickness, t₁, of the cell may be within a range formed by selecting any two numbers listed in the immediately previous sentence, e.g., between about 100 μm and about 5,000 μm or about 100 μm and about 1,000 μm.

### Cathode Electrode Generally

The cathode electrode is associated with one polarity (e.g., positive) of the solid-state battery. The cathode electrode is configured as a positive electrode during discharge of the solid-state battery. The cathode electrode is suitable for lithium ion diffusion between a current collector and the solid electrolyte layer. The cathode electrode is in electrical communication with the current collector. In some aspects, the cathode electrode is formed over and in direct contact with the current collector. In other some aspects, another functional layer may be interposed between the cathode electrode and the current collector.

### Material for the Cathode Electrode

The cathode electrode may be capable of reversible intercalation and deintercalation of lithium ions. For example, the cathode electrode can comprise one or more of a cathode active material, a conductive carbon, a solid electrolyte material, a binder, the like, or combinations thereof. Optionally, the cathode electrode 102 may further comprise an additive, such as, for example, an oxidation stabilizing agent, a reduction stabilizing agent, a flame retardant, a heat stabilizer, an antifogging agent, a thickener, the like, or a combination thereof. Examples of these additives may include butylated hydroxyanisole (BHA) or butylated hydroxytoluene (BHT) as oxidation stabilizing agents, ascorbic acid or sodium sulfite as reduction stabilizing agents, aluminum hydroxide or magnesium hydroxide as flame retardants, phenolic compounds or phosphites as heat stabilizers, polyethylene glycol or silica nanoparticles as antifogging agents, and carboxymethyl cellulose (CMC) or xanthan gum as thickeners.

### Material for the Cathode Active Material

The cathode active material can include lithium cobalt oxide (LiCoO₂), lithium nickel oxide (LiNiO₂), Li[NiₐCO_{b}Mn_{c}M¹_{d}]O₂ (wherein M¹ is any one element elected from the group consisting of Al, Ga, In, or a combination thereof, 0.3≤a<1.0, 0≤b≤0.5, 0≤c≤0.5, 0≤d≤0.1, and a+b+c+d=1), Li(LiₑM²_{f-e-f}M³_{f′})O_{2-g}A_{g} (wherein 0≤e≤0.2, 0.6≤f≤1, 0≤f′≤0.2, 0≤g≤0.2, M² includes Mn and at least one element selected from the group consisting of Ni, Co, Fe, Cr, V, Cu, Zn and Ti, M³ is at least one element selected from the group consisting of Al, Mg and B, and A is at least one element selected from the group consisting of P, F, S and N), or those compounds substituted with one or more transition metals; lithium manganese oxides such as those represented by the chemical formula of Li^{1+h}Mn₂₋ₕO₄ (wherein 0≤h≤0.33), LiMnO₃, LiMn₂O₃, LiMnO₂, or the like; lithium copper oxide (Li₂CuO₂); vanadium oxides such as LiV₃O₈, V₂O₅ or Cu₂V₂O₇; Ni-site type lithium nickel oxides represented by the chemical formula of LiNi₁₋ᵢM⁴ᵢO₂ (wherein M⁴=Co, Mn, Al, Cu, Fe, Mg, B or Ga, and 0.01≤y≤0.3); lithium manganese composite oxides represented by the chemical formula of LiMn₂₋ⱼM⁵ⱼO₂ (wherein M⁵=Co, Ni, Fe, Cr, Zn, or Ta, and 0.01≤y≤0.1) or Li₂Mn₃M⁶O₈ (wherein M⁶=Fe, Co, Ni, Cu, or Zn); LiMn₂O₄ in which Li is partially substituted with an alkaline earth metal ion; disulfide compounds; LiFe₃O₄, Fe₂(MoO₄)₃; the like; or combinations thereof.

In addition to the cathode active materials previously mentioned, the cathode electrode may include other types of materials. For example, lithium iron phosphate (LiFePO₄) may be used as a cathode active material due to its excellent thermal stability and long cycle life. Other phosphate-based materials such as lithium manganese iron phosphate (LiMnₓFe₁₋ₓPO₄) or lithium cobalt phosphate (LiCoPO₄) may also be suitable.

The cathode active material may also include layered oxide materials with various compositions, such as Li(Ni_{1-x-y}CoₓMn_{y})O₂ (NCM) or Li(Ni_{1-x-y}CoₓAl_{y})O₂ (NCA), where the ratios of Ni, Co, Mn, and Al can be adjusted to optimize performance characteristics. For instance, NCM materials with high nickel content, such as NCM811 (LiNi_{0.8}Co_{0.1}Mn_{0.1}O₂), may be used to achieve higher energy density. In some cases, the cathode active material may comprise spinel structures like LiNi_{0.5}Mn_{1.5}O₄, which can offer high voltage operation. Alternatively, materials with favorite structures, such as LiFeSO₄F or LiVPO₄F, may be employed for their potential for high energy density and good thermal stability.

Composite or blended cathode materials, combining two or more active materials, may also be used. For example, a blend of layered oxides and spinel materials might be employed to balance energy density and power capability. As another example, lithium iron phosphate may be blended with one or more of the cathode active materials described above. In some aspects, the cathode active material may include surface-modified versions of the aforementioned compounds, where the surface modification aims to improve stability, conductivity, or other performance metrics.

The cathode active material may also include emerging classes of materials such as disordered rock salt structures (e.g., Li₃NbO₄-based materials) or high-entropy oxides, which may offer unique combinations of high capacity and structural stability. In some cases, the cathode active material may incorporate dopants or substitutional elements to further tune its electrochemical properties.

### Particulate Nature of the Cathode Active Material

The cathode active material can be particle shaped. The cathode active material can comprise a particle size of about 10 nm, 20 nm, 30 nm, 50 nm, 70 nm, 100 nm, 200 nm, 300 nm, 400 nm, 500 nm, 1,000 nm, 10 μm, 20 μm, 30 μm, 50 μm, 70 μm, 100 μm, 200 μm, 300 μm, 400 μm, 500 μm, or 1,000 μm. In some aspects, particle size of the cathode active material may be within a range formed by selecting any two numbers listed in the immediately previous sentence, e.g., between about 10 nm and about 1,000 μm. Gaps between cathode active material in the cathode electrode can be filled with the solid electrolyte material.

### Amount of the Cathode Active Material in the Cathode Electrode

The amount of the cathode active material in the solid-state battery affects the charge and discharge capacity of the solid-state battery. In order to manufacture a high-capacity cathode electrode, a high level of cathode active material can be included in the cathode electrode. For example, the cathode electrode includes at, about, or greater than 30, 40, 50, 60, 70, 80, 90, 95, or 98 wt % of cathode active material based on the total weight of the cathode electrode. In some aspects, cathode active material in the cathode electrode may be within a range formed by selecting any two numbers listed in the immediately previous sentence, e.g., between about 40 wt % and about 98 wt %.

### Material for the Conductive Material in the Cathode Electrode

The conductive material in the cathode electrode is not particularly limited, as long as it has conductivity while not causing any chemical change in the corresponding solid-state battery. For example, the conductive material can comprise graphite, such as natural graphite or artificial graphite; carbon black, such as acetylene black, ketjen black, channel black, furnace black, lamp black or thermal black; conductive fibers, such as carbon fibers or metal fibers; carbon nanotubes (CNT), including both singled-walled carbon nanotubes (SWCNT) and multi-walled carbon nanotubes (MWCNT); metal powder, such as fluorocarbon, aluminum or nickel powder; conductive whiskers, such as zinc oxide or potassium titanate; conductive metal oxides, such as titanium oxide; conductive materials, such as polyphenylene derivatives; the like; or combinations thereof. Other conductive materials that may be used in the cathode electrode include graphene and its derivatives, such as reduced graphene oxide (rGO) or graphene nanoplatelets. These two-dimensional carbon materials offer high surface area and excellent electrical conductivity. Conductive polymers, such as polyaniline (PANI), polypyrrole (PPy), or poly(3,4-ethylenedioxythiophene) (PEDOT), may also be employed to enhance the electrode's conductivity while potentially improving its mechanical properties. In some cases, hybrid conductive additives combining different materials, such as CNT-graphene composites or metal-coated carbon materials, may be used to synergistically improve the overall conductivity and performance of the cathode electrode.

### Amount of Conductive Material in the Cathode Electrode

The cathode electrode includes at or about 1, 2, 5, 10, 15, 20, 25, or 30 wt % of conductive material based on the total weight of the cathode electrode. In some aspects, conductive material in the cathode electrode may be within a range formed by selecting any two numbers listed in the immediately previous sentence, e.g., between about 1 wt % and about 30 wt %.

### Material for the Binder

The binder can comprise various types of binder polymers, such as, for example, polyvinylidene fluoride-co-hexafluoropropylene (PVdF-co-HFP), polyvinylidene fluoride, polyacrylonitrile, polymethyl methacrylate, polyvinyl alcohol, carboxymethyl cellulose (CMC), starch, hydroxypropyl cellulose, regenerated cellulose, polyvinyl pyrrolidone, tetrafluoroethylene, polyethylene, polypropylene, polyacrylate, ethylene-propylene-diene monomer (EPDM), sulfonated EPDM, styrene butadiene rubber (SBR), fluororubber, polyacrylic acid, polymers thereof whose hydrogen atoms are substituted with Li, Na or Ca, various copolymers thereof, the like, or combinations thereof. In addition to the binder materials previously mentioned, other types of binder materials may be used in the cathode electrode to enhance its performance and stability. For instance, water-soluble binders such as sodium alginate, gelatin, or polyacrylamide may be employed to improve the environmental friendliness of the electrode manufacturing process. These binders may also offer advantages in terms of electrode flexibility and adhesion strength. In some cases, conductive binders like poly(3,4-ethylenedioxythiophene): poly(styrene sulfonate) (PEDOT: PSS) or polyaniline (PANI) may be used to simultaneously improve both the mechanical integrity and electrical conductivity of the electrode. Novel binder systems, such as self-healing polymers or supramolecular assemblies, may be incorporated to enhance the long-term stability and cycle life of the battery. Additionally, composite binders combining multiple polymers or incorporating inorganic nanoparticles may be utilized to tailor the mechanical, thermal, and electrochemical properties of the electrode. In some aspects, bio-derived or biodegradable binders, such as cellulose derivatives or chitosan, may be employed to reduce the environmental impact of battery production and disposal.

### Amount of Binder in the Cathode Electrode

The cathode electrode includes at or about 1, 2, 5, 10, 15, 20, 25, or 30 wt % of binder based on the total weight of the cathode electrode. In some aspects, binder in the cathode electrode may be within a range formed by selecting any two numbers listed in the immediately previous sentence, e.g., between about 1 wt % and about 30 wt %.

### Material for Solid Electrolyte Material

The solid electrolyte material in the cathode electrode can be individually configured the same as the material for the solid electrolyte layer discussed below. The solid electrolyte material in the cathode electrode can be the same or different than the material for the solid electrolyte layer.

### Amount of Solid Electrolyte Material in Cathode Electrode

The cathode electrode 102 includes about 1, 2, 5, 10, 15, 20, 25, or 30 wt % of solid electrolyte material based on the total weight of the cathode electrode. In some aspects, the amount of solid electrolyte material in the cathode electrode may be within a range formed by selecting any two numbers listed in the immediately previous sentence, e.g., between about 1 wt % and about 30 wt %.

### Thickness of Cathode Electrode

A thickness, t₂, of the cathode electrode can be about 10, 20, 50, 100, 150, 200, 250, 300, 400, 500, or 1,000 μm. In some aspects, the thickness, t₂, of the cathode electrode may be within a range formed by selecting any two numbers listed in the immediately previous sentence, e.g., between about 10 μm and about 1,000 μm.

### Porosity of Cathode Electrode

A porosity of the cathode electrode can be about 0, 1, 2 3, 4, 5, 6, 7, 8, 9, 10, 11, 12, 13, 14, 15, 16, 17, or 18 vol % based on the total volume of the cathode electrode. In some aspects, the porosity of the cathode electrode may be within a range formed by selecting any two numbers listed in the immediately previous sentence, e.g., between 0 vol % and about 18 vol %.

### Lithium Ion Diffusivity of the Cathode Electrode

The cathode electrode can include a lithium ion diffusivity of at or about 1×10⁻¹⁴ cm²/s, 1×10⁻¹³ cm²/s, 1×10⁻¹² cm²/s, 1×10⁻¹¹ cm²/s, 1×10⁻¹⁰ cm²/s, 1×10⁻⁹ cm²/s, 1×10⁻⁸ cm²/s, or 1×10⁻⁷ cm²/s. In some aspects, the lithium ion diffusivity of the cathode electrode may be within a range formed by selecting any two numbers listed in the immediately previous sentence, e.g., between 1×10⁻¹⁴ cm²/s and about 1×10⁻⁷ cm²/s.

### Current Collector at the Cathode Electrode

The current collector collects electrical energy generated at the cathode electrode and supports the cathode electrode. The material of the current collector is not particularly limited as long as it allows adhesion of the cathode electrode, has a suitable electrical conductivity, and does not cause significant chemical changes in the corresponding solid-state battery in the voltage range of the solid-state battery. For example, the current collector is made of or includes various materials, such as, a metal, a conductive carbon, or a conductive ceramic, although not limited thereto. The metal of the current collector may include one or more selected from the group consisting aluminum, an aluminum alloy, copper, a copper alloy, nickel, a nickel alloy, titanium, a titanium alloy, iron, an iron alloy (e.g., steel, stainless steel), silver, a silver alloy, gold, platinum, palladium, chromium, molybdenum, tungsten, tantalum, niobium, zirconium, vanadium, manganese, cobalt, indium, tin, lead, bismuth, or a combination thereof, although not limited thereto.

### Shape and Size of the Current Collector at the Cathode Electrode

It is possible to increase the adhesion of the cathode electrode to the current collector by forming fine surface irregularities on the surface of the current collector. The current collector may have various shapes, such as, for example, a film, a sheet, a foil, a net, a porous body, a foam, a non-woven web body, the like, or combinations thereof. The current collector may also be configured in various other geometries to optimize its performance and integration with the cathode electrode, and may be sized for specific form factors, such as pouch, cylindrical, and/or prismatic form factors. For instance, the current collector may be structured as a mesh or grid, which can provide enhanced mechanical support while maintaining high surface area for electrode adhesion. In some aspects, the current collector may be designed with a corrugated or wavy pattern, potentially increasing the contact area with the cathode material and improving overall conductivity. The current collector may also be fabricated as a perforated sheet, allowing for better electrolyte penetration and ion transport. In certain cases, the current collector may be formed as a three-dimensional structure, such as an interconnected network of fibers or a honeycomb-like configuration, which could enhance the structural integrity of the electrode assembly while facilitating efficient current collection.

### Thickness of Current Collector at the Cathode Electrode

A thickness, t₃, of the current collector can be about 3, 5, 10, 15, 20, 25, 50, 100, 150, 200, 300, 400, or 500 μm. In some aspects, the thickness, t₃, of the current collector 108 may be within a range formed by selecting any two numbers listed in the immediately previous sentence, e.g., between about 5 μm and about 500 μm.

### Manufacturing Method for the Cathode Electrode

The cathode electrode may be obtained by various methods. For example, the cathode active material can be mixed and agitated with a solvent, and optionally a binder, conductive material, and a dispersing agent to form slurry. Then, the slurry can be applied (e.g., coated) onto the current collector, followed by pressing and drying, to obtain the cathode electrode.

In addition to the slurry-based method described, the cathode electrode may be manufactured using various other techniques. For instance, a dry powder coating process may be employed, where the cathode active material, conductive additives, and binder are mixed in a dry state and then directly applied to the current collector using electrostatic deposition or mechanical compression. This method may reduce environmental impact by eliminating the need for solvents.

In some cases, the cathode electrode may be fabricated using additive manufacturing techniques such as 3D printing. This approach allows for precise control over the electrode structure and porosity, potentially enhancing the electrode's performance and energy density. Various 3D printing methods, including fused deposition modeling (FDM), selective laser sintering (SLS), or direct ink writing (DIW), may be utilized depending on the specific materials and desired electrode properties.

Another method for manufacturing the cathode electrode may involve electrospinning. In this process, a solution containing the cathode active material, conductive additives, and a polymer binder is extruded through a nozzle under an electric field, resulting in the formation of nanofibers. These fibers can be collected directly on the current collector to form a highly porous electrode structure with increased surface area.

In some aspects, the cathode electrode may be prepared using a tape casting method. This technique involves spreading a slurry of electrode materials onto a moving carrier film using a doctor blade, followed by drying and calendering. The resulting electrode tape can then be laminated onto the current collector.

Alternatively, the cathode electrode may be fabricated using a spray coating technique. In this method, a fine mist of the electrode slurry is sprayed onto the current collector using compressed air or ultrasonic atomization. This approach may allow for the creation of thin, uniform electrode layers and can be particularly useful for large-scale production.

In certain cases, the cathode electrode may be manufactured using a freeze-casting method. This process involves freezing a slurry of electrode materials, followed by sublimation of the ice to create a porous structure. The resulting porous electrode can then be sintered and attached to the current collector.

For some applications, the cathode electrode may be prepared using a sol-gel process. This method involves the formation of a colloidal suspension (sol) that is then converted into a gel-like network containing the cathode active material and other components. The gel can be applied to the current collector 108 and subsequently heat-treated to form the final electrode structure.

### Application Methods for the Slurry for the Cathode Electrode

The application of the slurry to the cathode electrode may include using a technique selected from the group consisting of slot die coating, gravure coating, spin coating, spray coating, roll coating, curtain coating, extrusion, casting, screen printing, inkjet printing, screen printing, inkjet printing, spray printing, gravure printing, heat transfer printing, a Toppan printing method, intaglio printing, offset printing, the like, and combinations thereof. In some aspects, the cathode electrode may be fabricated using a double layer slot die coating (DLD) technique. This method involves the simultaneous application of two distinct layers of electrode materials onto the current collector in a single pass. The DLD process may allow for the creation of gradient structures within the electrode, potentially optimizing both the electrochemical performance and mechanical properties of the cathode. Additionally, this technique may enable the incorporation of functional interlayers or protective coatings as part of the electrode manufacturing process, potentially enhancing the overall battery performance and longevity.

### Solvent for the Slurry for the Cathode Electrode

The solvent for forming the cathode electrode may include water and/or an organic solvent, such as, for example, N-methyl pyrrolidone (NMP), dimethyl formamide (DMF), acetone, dimethyl acetamide, dimethyl sulfoxide (DMSO), isopropyl alcohol, the like, or combinations thereof. The solvent may be used in an amount sufficient to dissolve and disperse the electrode ingredients, such as the cathode active material, binder, and conductive material, considering the slurry coating thickness, production yield, the like, or combinations thereof. Additional solvents that may be used include ethanol, methanol, propanol, butanol, ethyl acetate, methyl ethyl ketone, tetrahydrofuran, diethyl ether, and toluene. In some aspects of the disclosure, the cathode electrode may be prepared using a solvent-free method, such as dry powder processing or melt extrusion, which eliminates the need for liquid solvents and may offer environmental and cost benefits.

### Dispersing Agent for the Slurry for the Cathode Electrode

The dispersing agent forming the cathode electrode may include an aqueous dispersing agent and/or an organic dispersing agent, such as, for example, N-methyl-2-pyrrolidone. Other possible dispersing agents may include polyvinylpyrrolidone (PVP), carboxymethyl cellulose (CMC), sodium dodecyl sulfate (SDS), Triton X-100, polyethylene glycol (PEG), polyacrylic acid (PAA), and various surfactants such as polysorbates or poloxamers.

### Drying Technique for the Cathode Electrode

The slurry for the cathode electrode may be dried by irradiating heat, electron beams (E-beams), gamma rays, or UV (G, H, I-line), the like, or combinations thereof, to vaporize the solvent. For example, the slurry may be vacuum dried at room temperature. Although the solvent is removed through evaporation by the drying step, the other ingredients do not evaporate and remain as they are to form the cathode electrode. In addition to the drying techniques mentioned, the cathode electrode may be dried using other methods such as infrared (IR) drying, microwave drying, or freeze-drying. In some aspects, a combination of drying techniques may be employed, such as using convection heating followed by vacuum drying, to optimize the drying process and ensure complete solvent removal while maintaining the integrity of the electrode structure.

### Anode Electrode Generally

The anode electrode is associated with one polarity (e.g., negative) of the solid-state battery, which is different than the polarity of the cathode electrode. The anode electrode is configured as a negative electrode during discharge of the solid-state battery. The anode electrode is suitable for lithium ion diffusion between a current collector and the solid electrolyte layer. The anode electrode is in electrical communication with the current collector. In some aspects, the anode electrode is formed over and in direct contact with the current collector. In some aspects, as explained above, the solid-state battery may utilize an anodeless electrode system. In such configurations, the anode electrode may be omitted, and lithium metal may be deposited directly onto the current collector during charging. This approach may potentially increase the energy density of the battery by eliminating the need for a separate anode material, while also potentially reducing the overall thickness of the battery structure.

### Material for the Anode Electrode

The anode electrode may be capable of reversible intercalation and deintercalation of lithium ions. For example, the anode electrode can comprise an anode active material, a binder, the like, or combinations thereof. Optionally, the anode electrode may further comprise an additive, such as, for example, an oxidation stabilizing agent (e.g., butylated hydroxyanisole, butylated hydroxytoluene, propyl gallate, tert-butylhydroquinone), a reduction stabilizing agent (e.g., ascorbic acid, sodium sulfite, erythorbic acid, sodium metabisulfite), a flame retardant (e.g., aluminum hydroxide, magnesium hydroxide, ammonium polyphosphate, melamine cyanurate), a heat or light stabilizer (e.g., phenolic compounds, phosphites, hindered amine light stabilizers, UV absorbers like benzophenones or benzotriazoles), an antifogging agent (e.g., polyethylene glycol, silica nanoparticles, glycerol, sorbitol), a thickener (e.g., carboxymethyl cellulose, xanthan gum), the like, or a combination thereof. Additionally, conductive additives such as carbon black, graphene, or carbon nanotubes may be incorporated to enhance electrical conductivity, while binder modifiers like styrene-butadiene rubber or polyacrylic acid may improve adhesion and mechanical stability. Functional additives such as fluoroethylene carbonate or vinylene carbonate may also be included to promote the formation of a stable solid electrolyte interphase layer on the anode surface.

### Material for the Anode Active Material

The anode active material is made of or includes various materials, such as, for example, an alkali earth metal, an alkaline earth metal, a group 3B metal, a transition metal, a metalloid, an alloy thereof, a conductive carbon, the like, or a combination thereof, although not limited thereof. In some aspects, the anode active material can comprise silicon, a silicon alloy, lithium, a lithium alloy, a conductive carbon, or a combination thereof, although not limited thereto. In some aspects, the lithium alloy is made of or includes a lithium alloy comprising silicon, chlorine, or a combination thereof. The anode active material can include carbon-based material such as artificial graphite, natural graphite, graphitized carbon fiber, amorphous carbon or the like; a metallic compound capable of alloying with lithium such as Si, Al, Sn, Pb, Zn, Bi, In, Mg, Ga, Cd, a Si alloy, a Sn alloy, an Al alloy, or the like; a metal oxide capable of doping and dedoping lithium ions such as SiOx (0<x<2), SnO₂, vanadium oxide or lithium vanadium oxide; and a composite including the metallic compound and the carbon-based material such as a Si—C composite or a Sn—C composite. A lithium metal thin film may be used as the anode active material. The carbon-based material can include low-crystallinity carbon, high-crystallinity carbon, the like, or combinations thereof. A representative example of low-crystallinity carbon is soft carbon or hard carbon, and a representative example of the high-crystallinity carbon is high-temperature calcined carbon such as amorphous, platy, flaky, spherical or fibrous natural graphite or artificial graphite, kish graphite, pyrolytic carbon, mesophase pitch-based carbon fiber, meso-carbon microbeads, mesophase pitches, petroleum or coal tar pitch-derived coke, the like, or combinations thereof. In addition to the materials mentioned, the anode active material may also include titanium-based compounds such as lithium titanate (Li₄Ti₅O₁₂) or titanium dioxide (TiO₂), which can offer excellent cycling stability and high-rate capability. Other potential materials may include transition metal oxides like molybdenum oxides (MoOx), iron oxides (FeOx), or nickel oxides (NiOx), which can provide high theoretical capacities. In some cases, composite materials combining different active materials, such as silicon-graphite composites or tin-carbon composites, may be used to leverage the advantages of multiple materials while mitigating their individual limitations.

### Dendrite Formation

When the anode electrode is made of or includes lithium or a lithium alloy, dendrites may form on the anode electrode. The dendrites are a metallic lithium structure formed when extra lithium ions accumulate on a surface of the anode electrode. The formed dendrites may damage the solid electrolyte layer, reduce battery capacity of the solid-state battery, and/or otherwise lead to undesired performance of the solid-state battery. Dendrite formation is a significant challenge in lithium-based batteries, as these structures can grow through the electrolyte, potentially causing short circuits and safety hazards. The growth rate and morphology of dendrites may be influenced by factors such as current density, temperature, and the nature of the electrolyte-electrode interface.

Solid electrolytes offer several advantages over liquid electrolytes when it comes to mitigating dendrite formation. The mechanical strength of solid electrolytes may help suppress dendrite growth by providing a physical barrier to lithium metal penetration. Additionally, the uniform ion distribution in solid electrolytes may promote more even lithium deposition, reducing the likelihood of localized dendrite nucleation. Some solid electrolytes may also form a stable interface with the lithium metal anode, further inhibiting dendrite formation. However, it is important to note that while solid electrolytes can significantly reduce the risk of dendrite growth, they may not completely eliminate it, and ongoing research aims to develop advanced solid electrolyte materials with enhanced dendrite suppression capabilities.

### Nature of the Anode Active Material

The anode active material can be particle shaped or it may be a continuous, unitary form (e.g., a thin film or sheet). In some aspects where the anode active material is particle shaped, the anode active material can comprise a particle size of about 10 nm, 20 nm, 30 nm, 50 nm, 70 nm, 100 nm, 200 nm, 300 nm, 400 nm, 500 nm, 1,000 nm, 10 μm, 20 μm, 30 μm, 50 μm, 70 μm, 100 μm, 200 μm, 300 μm, 400 μm, 500, or 1,000 μm. In some aspects, particle size of the anode active material may be within a range formed by selecting any two numbers listed in the immediately previous sentence, e.g., between about 10 nm and about 1,000 μm.

### Amount of Anode Active Material in the Anode Electrode

The amount of the anode active material in the solid-state battery affects the charge and discharge capacity of the solid-state battery. In order to manufacture a high-capacity anode electrode, a high level of anode active material can be included in the anode electrode. For example, the anode electrode includes at, about, or greater than 70, 80, 90, 95, 98, 99, or 100 wt % of anode active material based on the total weight of the anode electrode. In some aspects, anode active material in the anode electrode may be within a range formed by selecting any two numbers listed in the immediately previous sentence, e.g., between about 70 wt % and about 100 wt %.

### Material for Binder in the Anode Electrode

The binder can comprise various types of binder polymers, such as, for example, polyvinylidene fluoride-co-hexafluoropropylene (PVdF-co-HFP), polyvinylidene fluoride, polyacrylonitrile, polymethyl methacrylate, polyvinyl alcohol, carboxymethyl cellulose (CMC), starch, hydroxypropyl cellulose, regenerated cellulose, polyvinyl pyrrolidone, tetrafluoroethylene, polyethylene, polypropylene, polyacrylate, ethylene-propylene-diene monomer (EPDM), sulfonated EPDM, styrene butadiene rubber (SBR), fluororubber, polyacrylic acid, polymers thereof whose hydrogen atoms are substituted with Li, Na or Ca, various copolymers thereof, the like, or combinations thereof. In addition to the binders mentioned, other suitable binders for use in the anode electrode may include polyimide, polyamide-imide, polyurethane, polyethylene oxide (PEO), poly(ethylene-co-vinyl acetate) (PEVA), poly(vinyl acetate) (PVA), alginate, chitosan, guar gum, xanthan gum, carrageenan, pectin, gelatin, lignin, and various water-soluble polymers or their derivatives. In some cases, conductive polymers such as polypyrrole, polyaniline, or poly(3,4-ethylenedioxythiophene) (PEDOT) may also be used as binders to simultaneously improve adhesion and electrical conductivity within the anode electrode.

### Amount of Binder in the Anode Electrode

The anode electrode can include at or about 0, 1, 2, 5, 10, 15, 20, 25, or 30 wt % of binder based on the total weight of the anode electrode. In some aspects, binder in the anode electrode may be within a range formed by selecting any two numbers listed in the immediately previous sentence, e.g., between about 0 wt % and about 30 wt %.

### Thickness of the Anode Electrode

The anode electrode can be about 10, 20, 30 50, 60, 70, or 100 μm thick. In some aspects, the thickness, t₄, of the anode electrode may be within a range formed by selecting any two numbers listed in the immediately previous sentence, e.g., between about 10 μm and about 100 μm or about 10 μm and about 20 μm.

### Porosity of Anode Electrode

A porosity of the anode electrode can be about 0, 1, 2 3, 4, 5, 6, 7, 8, 9, 10, 11, 12, 13, 14, 15, 16, 17, or 18 vol % based on the total volume of the anode electrode. In some aspects, the porosity of the anode electrode may be within a range formed by selecting any two numbers listed in the immediately previous sentence, e.g., between 0 vol % and about 18 vol %.

### Lithium Ion Diffusivity of the Anode Electrode

The anode electrode can include a lithium ion diffusivity of about 1×10⁻¹⁴ cm²/s, 1×10⁻¹³ cm²/s, 1×10⁻¹² cm²/s, 1×10⁻¹¹ cm²/s, 1×10⁻¹⁰ cm²/s, 1×10⁻⁹ cm²/s, 1×10⁻⁸ cm²/s, or 1×10⁻⁷ cm²/s. In some aspects, the lithium ion diffusivity of the anode electrode may be within a range formed by selecting any two numbers listed in the immediately previous sentence, e.g., between 1×10⁻¹⁴ cm²/s and about 1×10⁻⁷ cm²/s.

### Current Collector at the Anode Electrode

The current collector collects electrical energy generated at the anode electrode and supports the anode electrode. The material of the current collector is not particularly limited as long as it allows adhesion of the anode electrode, has a suitable electrical conductivity, and does not cause significant chemical changes in the corresponding solid-state battery in the voltage range of the solid-state battery. For example, the current collector is made of or includes a metal or a conductive carbon, although not limited thereto. The metal of the current collector may include one or more selected from the group consisting of aluminum, an aluminum alloy, copper, a copper alloy, nickel, a nickel alloy, titanium, a titanium alloy, iron, an iron alloy (e.g., steel, stainless steel), silver, a silver alloy, or a combination thereof, although not limited thereto.

### Shape and Size of the Current Collector at the Anode Electrode

It is possible to increase the adhesion of the anode electrode to the current collector by forming fine surface irregularities on the surface of the current collector. The current collector may have various shapes, such as, for example, a film, a sheet, a foil, a net, a porous body, a foam, a non-woven web body, the like, or combinations thereof. In addition to the shapes mentioned, the current collector may also be configured as a honeycomb structure, a perforated sheet, a woven or non-woven mesh, a sintered porous body, or a three-dimensional interconnected network. These various shapes can be tailored to optimize the surface area, mechanical strength, and current collection efficiency of the current collector. Furthermore, the current collector may be designed to accommodate different form factors of solid-state batteries, such as pouch cells, cylindrical cells, or prismatic cells, each offering unique advantages in terms of packaging efficiency, thermal management, and overall battery performance.

### Thickness of Current Collector at the Anode Electrode

A thickness, t₅, of the current collector can be about 3, 5, 10, 15, 20, 25, 50, 100, 150, 200, 300, 400, or 500 μm. In some aspects, the thickness, t₅, of the current collector may be within a range formed by selecting any two numbers listed in the immediately previous sentence, e.g., between about 5 μm and about 500 μm.

### Manufacturing Method for the Anode Electrode

The anode electrode may be obtained by various methods, such as, for example, atomic deposition, extrusion, rolling, a slurry method, or a combination thereof. For example, the anode active material can be mixed and agitated with a solvent, and optionally a binder, and a dispersing agent to form slurry. Then, the slurry can be applied (e.g., coated) onto the current collector, followed by pressing and drying, to obtain the anode electrode. In addition to the methods mentioned, the anode electrode may be manufactured using various other techniques, including dry electrode processes. These alternative methods may offer advantages in terms of environmental impact, cost-effectiveness, and scalability.

Dry powder coating may be employed as an alternative to the slurry method. In this process, the anode active material, conductive additives, and binder are mixed in a dry state and then directly applied to the current collector using electrostatic deposition or mechanical compression. This method eliminates the need for solvents, potentially reducing environmental impact and processing time.

Additive manufacturing techniques, such as 3D printing, may be used to fabricate the anode electrode. Various 3D printing methods, including fused deposition modeling (FDM), selective laser sintering (SLS), or direct ink writing (DIW), can be utilized depending on the specific materials and desired electrode properties. This approach allows for precise control over the electrode structure and porosity.

Electrospinning is another potential method for manufacturing the anode electrode. In this process, a solution containing the anode active material, conductive additives, and a polymer binder is extruded through a nozzle under an electric field, resulting in the formation of nanofibers. These fibers can be collected directly on the current collector to form a highly porous electrode structure with increased surface area.

Tape casting may be employed to prepare the anode electrode. This technique involves spreading a slurry of electrode materials onto a moving carrier film using a doctor blade, followed by drying and calendaring. The resulting electrode tape can then be laminated onto the current collector.

Spray coating techniques may be used to fabricate the anode electrode. A fine mist of the electrode slurry is sprayed onto the current collector using compressed air or ultrasonic atomization. This approach may allow for the creation of thin, uniform electrode layers and can be particularly useful for large-scale production.

Freeze-casting is another potential method for manufacturing the anode electrode. This process involves freezing a slurry of electrode materials, followed by sublimation of the ice to create a porous structure. The resulting porous electrode can then be sintered and attached to the current collector.

In some cases, a sol-gel process may be used to prepare the anode electrode. This method involves the formation of a colloidal suspension (sol) that is then converted into a gel-like network containing the anode active material and other components. The gel can be applied to the current collector and subsequently heat-treated to form the final electrode structure.

For certain applications, physical vapor deposition (PVD) or chemical vapor deposition (CVD) techniques may be employed to create thin film anodes directly on the current collector. These methods can produce highly uniform and dense electrode layers, which may be particularly beneficial for certain types of solid-state batteries.

Lastly, mechanical alloying and high-energy ball milling may be used to prepare composite anode materials, which can then be pressed into electrodes or applied to the current collector using one of the aforementioned methods. This technique can be particularly useful for creating nanostructured or amorphous anode materials with enhanced electrochemical properties.

### Ball Milling Generally

Ball milling is a valuable technique for mixing and preparing materials for solid-state batteries. Ball milling is a mechanical technique widely used to grind powders into fine particles and mix materials in various applications, including the preparation of solid-state battery components. In the context of solid-state batteries, ball milling is often employed to mix and blend the electrode materials, solid electrolytes, and other components. Exemplary ball milling devices may include planetary ball mills, attritor mills, and vibratory ball mills. These devices typically consist of a rotating or vibrating chamber containing grinding balls made of materials such as steel, ceramic, or zirconia.

### Homogeneous Mixing

Ball milling is effective in achieving a homogeneous mixture of different powders. This is crucial for ensuring uniform distribution of components in the electrode materials and solid electrolytes, which, in turn, impacts the overall performance of the battery.

### Reducing Particle Size

Ball milling can reduce the particle size of the materials involved, leading to increased surface area and improved reactivity. Smaller particle sizes can enhance the kinetics of electrochemical reactions, contributing to better battery performance.

### Enhanced Electrode-Electrolyte Interface

Ball milling can facilitate the formation of a well-defined interface between the electrode and solid electrolyte. This is important for promoting efficient ion transport and minimizing interfacial resistance within the solid-state battery.

### Promoting Solid-State Reactions

Ball milling can induce solid-state reactions between different components, promoting the formation of desired phases and structures in the materials. This is particularly relevant for the synthesis of composite electrode materials or preparation of the composite electrolyte materials provided herein.

### Optimizing Conductivity

Ball milling can be used to optimize the conductivity of electrode materials by ensuring a good distribution of conductive additives, such as carbon or metal nanoparticles, within the composite; or the additive materials, within the solid electrolyte, as provided herein.

### Controlling Morphology

The milling process can also influence the morphology of the materials, including particle shape and size distribution. Controlling these aspects is important for achieving the desired electrochemical properties and overall performance of the solid-state battery.

### Energy Considerations

Ball milling is an energy-intensive process, and the duration and speed of milling need to be carefully controlled to avoid excessive heating, which could lead to undesired reactions or damage to the materials.

### Application Methods for Slurry for Anode Electrode

The application of the slurry for the anode electrode may include using a technique selected from the group consisting of slot die coating, gravure coating, spin coating, spray coating, roll coating, curtain coating, extrusion, casting, screen printing, inkjet printing, screen printing, inkjet printing, spray printing, gravure printing, heat transfer printing, a Toppan printing method, intaglio printing, offset printing, the like, and combinations thereof. In addition to the aforementioned techniques, other methods for applying the anode slurry to the current collector may include doctor blade coating, dip coating, and meniscus coating. Double slot die layer coating may also be employed, which allows for the simultaneous application of two distinct layers of electrode materials onto the current collector in a single pass. This method can potentially enable the creation of gradient structures within the electrode, optimizing both electrochemical performance and mechanical properties.

### Solvent for the Slurry for the Anode Electrode

The solvent for forming the anode electrode may include water and/or an organic solvent, such as, for example, N-methyl pyrrolidone (NMP), dimethyl formamide (DMF), acetone, dimethyl acetamide, dimethyl sulfoxide (DMSO), isopropyl alcohol, the like, or combinations thereof. The solvent may be used in an amount sufficient to dissolve and disperse the electrode ingredients, such as the anode active material and binder, considering the slurry coating thickness, production yield, the like, or combinations thereof. Additional organic solvents that may be used include ethanol, methanol, propanol, butanol, ethyl acetate, methyl ethyl ketone, tetrahydrofuran, diethyl ether, and toluene. In some aspects, the anode electrode may be prepared using a solvent-free method, such as dry powder processing or melt extrusion, which eliminates the need for liquid solvents and may offer environmental and cost benefits.

### Dispersing Agent for Slurry for the Anode Electrode

The dispersing agent forming the anode electrode may include an aqueous dispersing agent and/or an organic dispersing agent, such as, for example, N-methyl-2-pyrrolidone. The dispersing agent forming the anode electrode may include an aqueous dispersing agent and/or an organic dispersing agent, such as, for example, N-methyl-2-pyrrolidone. Other examples of aqueous dispersing agents may include sodium dodecyl sulfate (SDS), polyvinylpyrrolidone (PVP), and carboxymethyl cellulose (CMC), while additional organic dispersing agents may include Triton X-100, polyethylene glycol (PEG), and various surfactants such as polysorbates or poloxamers. In some aspects, the anode electrode may be prepared using methods that do not require a dispersing agent, such as dry powder processing or certain additive manufacturing techniques.

### Drying Technique for the Anode Electrode

The slurry for the anode electrode may be dried by irradiating heat, electron beams (E-beams), gamma rays, or UV (G, H, I-line), the like, or combinations thereof, to vaporize the solvent. For example, the slurry may be vacuum dried at room temperature. Although the solvent is removed through evaporation by the drying step, the other ingredients do not evaporate and remain as they are to form the anode electrode. In addition to the drying techniques mentioned, several other methods may be employed to dry the anode electrode slurry. These additional techniques can offer various advantages depending on the specific materials, production requirements, and desired electrode properties.

Infrared (IR) drying may be used to rapidly heat the electrode surface, promoting efficient solvent evaporation. This method can be particularly effective for thin electrode coatings and may allow for precise control of the drying process. Microwave drying is another option that can provide volumetric heating of the electrode material, potentially leading to more uniform drying throughout the electrode thickness. In some cases, a combination of convection and microwave drying may be employed to optimize both drying speed and uniformity.

Freeze-drying, also known as lyophilization, may be utilized for certain electrode formulations. This process involves freezing the slurry and then sublimating the solvent under vacuum conditions. Freeze-drying can help maintain the porous structure of the electrode, which may be beneficial for electrolyte penetration and ion transport.

Supercritical CO₂ drying is an advanced technique that may be employed for specialized electrode materials. This method involves replacing the solvent with liquid CO₂, which is then brought to its supercritical state and vented. This approach can help preserve delicate nanostructures within the electrode and may be particularly useful for aerogel-based electrodes.

In some cases, a two-step drying process may be employed. For example, initial drying may be performed at a lower temperature to remove bulk solvent, followed by a higher temperature step to remove residual solvent and potentially initiate any desired chemical reactions within the electrode material.

Ultrasonic drying may also be considered for certain electrode formulations. This technique uses high-frequency sound waves to agitate the solvent molecules, potentially accelerating the drying process and improving solvent removal from porous structures within the electrode.

### Solid Electrolyte Layer Generally

The solid electrolyte layer is suitable for lithium ion diffusion between the cathode electrode and the anode electrode. The solid electrolyte layer provides an electrically conductive pathway for the movement of charge carriers between the cathode electrode and the anode electrode. The solid electrolyte layer is in electrical communication with the cathode electrode and the anode electrode. In some aspects, the solid electrolyte layer is formed over and in direct contact with the cathode electrode or the anode electrode. In some aspects, the solid electrolyte layer is in direct contact with the cathode electrode and the anode electrode. In other aspects, another functional layer may be interposed between the solid electrolyte layer and the cathode electrode and/or the anode electrode.

The solid electrolyte layer may have a gradient structure, with composition or properties that vary across its thickness to optimize ion transport and interfacial compatibility. For example, the layer could have higher ionic conductivity near the electrodes and higher mechanical strength in the middle.

In some aspects, the solid electrolyte layer may be formed as a composite, incorporating both ceramic and polymer components to balance mechanical properties and ion conductivity. The ceramic component could provide structural stability while the polymer enhances flexibility and electrode contact.

The solid electrolyte layer may include engineered porosity or channels to facilitate ion transport while maintaining mechanical integrity. These could be created through techniques like freeze-casting or templating.

In certain configurations, the solid electrolyte layer may be applied as multiple thin sublayers with slightly different compositions or properties, allowing for fine-tuning of the overall layer characteristics.

The interface between the solid electrolyte and electrodes may be modified through surface treatments or the addition of buffer layers to improve adhesion and reduce interfacial resistance. This could involve plasma treatment, chemical modification, or deposition of nanoscale interface layers.

In some aspects, the solid electrolyte layer may incorporate self-healing properties, such as the inclusion of microcapsules containing electrolyte material that can repair small cracks or defects that form during cycling.

The solid electrolyte layer may be designed with anisotropic properties, having different ionic conductivities in different directions to optimize ion transport between electrodes while minimizing unwanted side reactions.

In certain configurations, the solid electrolyte layer may include embedded current collectors or conductive networks to enhance charge transport and distribution across the battery structure.

The solid electrolyte layer may be formulated to have temperature-dependent properties, optimizing performance across a wide range of operating conditions. This could involve phase-change materials or components with different thermal expansion coefficients.

In some aspects, the solid electrolyte layer may be designed to be pressure-sensitive, with ionic conductivity that improves under moderate compression to enhance performance during battery operation.

### Material for Solid Electrolyte Layer

The solid electrolyte layer may be capable of transport of lithium ions. The material of the solid electrolyte layer is not particularly limited as long as it allows adhesion with adjacent layers, has a suitable electrical conductivity, and does not cause significant chemical changes in the corresponding solid-state battery in the voltage range of the solid-state battery. For example, besides the composite solid electrolyte materials including the additive material and the sulfide containing solid electrolyte material provided herein, the solid electrolyte layer may include various inorganic solid electrolytes, polymer solid electrolytes, polymer gel electrolytes, although not limited thereto. Additionally, or alternatively, the solid electrolyte layer may include ceramic electrolytes, glass electrolytes, hybrid organic-inorganic electrolytes, and nanostructured electrolytes, although not limited to these categories.

### Inorganic Solid Electrolyte

The inorganic solid electrolyte may include a crystalline solid electrolyte, a non-crystalline solid electrolyte, a glass ceramic solid electrolyte, the like, or a combination thereof, although not limited thereto. The inorganic solid electrolyte may be sulfide-based, oxide-based, the like, or a combination thereof. In addition to sulfide-based and oxide-based inorganic solid electrolytes, other types of inorganic solid electrolytes may include halide-based electrolytes, nitride-based electrolytes, and borate-based electrolytes. For example, lithium-rich anti-perovskites (LiRAP) such as Li₃Ocl and Li₃Obr, lithium nitride (Li₃N), and lithium borohydride (LiBH₄) have been investigated as potential solid electrolyte materials for lithium-ion batteries.

### Sulfide Based Solid Electrolyte

As provided herein, the sulfide-based solid electrolyte includes sulfur(S) and has ionic conductivity of metal belonging to Group I or Group II of the periodic table, and may include Li—P—S-based glass or Li—P—S-based glass ceramics. For example, the sulfide-based solid electrolyte may include lithium sulfide, silicon sulfide, germanium sulfide and boron sulfide. Particular examples of the inorganic solid electrolyte may include Li_{3.833}Sn_{0.833}As_{0.166}S₄, Li₄SnS₄, Li_{3.25}Ge_{0.25}P_{0.75}S₄, Li₂S—P₂S₀, B₂S₃—Li₂S, Xli₂S-(100−x) P₂S₅ (x=70-80), Li₂S—SiS₂—Li₃N, Li₂S—P₂S₅—LiI, Li₂S—SiS₂—LiI, Li₂S—B₂S₃—LiI, Li₃N, LISICON, LIPON (Li_{3+y}PO₄₋ₓNₓ), thio-LISICON (Li_{3.25}Ge_{0.25}P_{0.75}S₄), Li₂O—Al₂O₃—TiO₂—P₂O₅ (LATP), Li₂S P₂S₅, Li₂S—LiI-P₂Ss, Li₂S—LiI—Li₂O-P₂Ss, Li₂S—LiBr-P₂Ss, Li₂S—Li₂O—P₂S₅, Li₂S Li₃PO₄—P₂S₅, Li₂S—P₂S₅—P₂O₅, Li₂S—P₂S₅—SiS₂, Li₂S—P₂S₅—SnS, Li₂S—P₂S₅—Al₂S₃, Li₂S—GeS₂, Li₂S—GeS₂—ZnS, Li₁₀GeP₂S₁₂ (LGPS), Li₇P₃S₁₁, Li₆PS₅Cl, Li₆PS₅Br, Li₆PS5I, Li_{9.54}Si_{1.74}P_{1.44}S_{11.7}Cl_{0.3}, Li₁₁Si₂PS₁₂, the like, or combinations thereof. In some cases, doped variants of these materials, such as Al-doped Li₁₀GeP₂S₁₂ or Sb-doped Li₆PS₅Cl, may also be employed to further enhance ionic conductivity or stability.

### Oxide-Based Solid Electrolyte

The oxide-based solid electrolyte material contains oxygen (O) and has ionic conductivity of metal belonging to Group I or II of the periodic table. The oxide-based solid electrolyte material may include at least one selected from the group consisting of LLTO-based compounds, Li₆La₂CaTa₂O₁₂, Li₆La₂Anb₂O₁₂ (A is Ca or Sr), Li₂Nd₃TeSbO₁₂, Li₃BO_{2.5}N_{0.5}, Li₉SiA₁O₈, LAGP-based compounds, LATP-based compounds, Li₁₊ₓTi₂₋ₓAlₓSi_{y}(PO₄)_{3-y}(0≤x≤1, 0≤y≤1), LiAlₓZr₂₋ₓ(PO₄)₃ (0≤x≤1, 0≤y≤1), LiTiₓZr₂₋ₓ(PO₄)₃ (0≤x≤1, 0≤y≤1), LISICON-based compounds, LIPON-based compounds, perovskite-based compounds, NASICON-based compounds and LLZO-based or derived compounds (such as Al-doped Li₇La₃Zr₂O₁₂ and Ta-doped Li₇La₃Zr₂O₁₂). Lithium-rich anti-perovskites like Li₃Ocl and Li₃Obr have also been investigated as potential oxide-based solid electrolytes. In some cases, composite oxide electrolytes combining multiple oxide materials, such as LLZO-LATP composites, may be employed to leverage the advantages of different oxide systems.

### Polymer Solid Electrolyte

The polymer solid electrolyte is a composite of electrolyte salt with polymer resin and has lithium ion conductivity. The polymer solid electrolyte may include a polyether polymer, a polycarbonate polymer, an acrylate polymer, a polysiloxane polymer, a phosphazene polymer, a polyethylene derivative, an alkylene oxide derivative, a phosphate polymer, a polyalginate lysine, a polyester sulfide, a polyvinyl alcohol, a polyvinylidene fluoride, a polymer containing an ionically dissociable group, poly(ethylene imine) (PEI), poly(methyl methacrylate) (PMMA), poly(acrylonitrile) (PAN), poly(ethylene succinate) (PES), biopolymers such as chitosan and cellulose derivatives, the like, or combinations thereof. The solid polymer electrolyte may include a polymer resin, such as a branched copolymer including polyethylene oxide (PEO) backbone copolymerized with a comonomer including an amorphous polymer, such as, for example, PMMA, polycarbonate, polydiloxane (pdms) and/or phosphazene, comb-like polymer, crosslinked polymer resin, polyethylene glycol (PEG), polypropylene oxide (PPO), polyacrylonitrile (PAN), poly(methyl methacrylate) (PMMA), poly(vinylidene fluoride-co-hexafluoropropylene) (PVDF-HFP), poly(ethylene oxide-co-propylene oxide) (PEO-PPO), poly(ethylene imine) (PEI), poly(vinyl pyrrolidone) (PVP), poly(vinyl alcohol) (PVA), various block copolymers or graft copolymers incorporating these materials, the like, or combinations thereof.

### Polymer Gel Electrolyte

The polymer gel electrolyte can be formed by incorporating an organic electrolyte containing an organic solvent and an electrolyte salt, an ionic liquid, monomer, or oligomer to a polymer resin, the like, or combinations thereof. The polymer resin for the polymer gel can include polyether polymers, PVC polymers, PMMA polymers, polyacrylonitrile (PAN), polyvinylidene fluoride (PVDF), poly(vinylidene fluoride-co-hexafluoropropylene: PVDF-co-HFP), the like, or combinations thereof. Examples of polymer gel electrolytes that may be suitable for solid state batteries include poly(ethylene oxide) (PEO), poly(methyl methacrylate-co-ethyl acrylate) (PMMA-EA), poly(acrylonitrile-co-methyl methacrylate) (PAN-MMA), poly(vinyl acetate) (PVAc), poly(ethylene glycol diacrylate) (PEGDA), poly(vinyl pyrrolidone) (PVP), poly(ethylene glycol methyl ether acrylate) (PEGMEA), poly(ethylene glycol methyl ether methacrylate) (PEGMEMA), poly(ionic liquid) (PIL), poly(ethylene glycol-co-propylene glycol) (PEG-PPG), poly(vinyl alcohol-co-ethylene) (PVA-PE), poly(acrylamide) (PAM), poly(2-hydroxyethyl methacrylate) (PHEMA), poly(ethylene glycol-co-polyethylene oxide) (PEG-PEO), and poly(methacrylic acid) (PMAA) based gel electrolytes to optimize the electrochemical and physical properties of the solid electrolyte.

### Electrolyte Salt

The electrolyte salt is an ionizable lithium salt and may be represented by Li⁺X⁻. X⁻ may include an anion selected from the group consisting of at least one selected from the group consisting of F⁻, Cl⁻, Br⁻, NO₃⁻, N(CN)₂⁻, BF₄⁻, ClO₄⁻, AlO₄⁻, AlCl₄⁻, PF₆⁻, SbF₆⁻, AsF₆⁻, BF₂C₂O₄⁻, BC₄O₈⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, C₄F₉SO₃⁻, CF₃CF₂SO₃⁻, (CF₃SO₂)₂N⁻, (F₂SO₂)₂N⁻, CF₃CF₂ (CF₃)₂CO⁻, (CF₃SO₂)₂CH, CF₃ (CF₂)₇SO₃⁻, CF₃CO₂⁻, CH₃CO₂⁻, SCN⁻, (CF₃CF₂SO₂)₂N⁻, and the like. For example, the lithium salt may be any one selected from the group consisting of LiTFSI, LiCl, LiBr, LiI, LiClO₄, lithium tetrafluoroborate (LiBF₄), LiB₁₀Cl₁₀, lithium hexafluorophosphate (LiPF₆), LiAsF₆, LiSbF₆, LiAlCl₄, LiSCN, LiCF₃CO₂, LiCH₃SO₃, LiCF₃SO₃, LIN (SO₂CF₃)₂, LIN (SO₂C₂F₅)₂, LiC₄F₉SO₃, LiC(CF₃SO₂)₃, (CF₃SO₂)·2NLi, lithium chloroborate, lithium lower aliphatic carboxylate, lithium imide 4-phenylborate, lithium bis(oxalato) borate (LiBOB), lithium difluoro (oxalato) borate (LiDFOB), lithium bis(fluorosulfonyl)imide (LiFSI), lithium 4,5-dicyano-2-(trifluoromethyl) imidazolide (LiTDI), lithium bis(trifluoromethanesulfonyl)imide (LiTFSI), and lithium bis(fluorosulfonyl)imide (LiFSI), the like, and combinations thereof. The electrolyte salt can include any combination of the salts described herein.

### Amount of Electrolyte Salt

The solid electrolyte layer 106 can include at or about 0, 50, 60, 70, 80, 100, 200, 300, or 400 parts of electrolyte salt, if present, based on the total weight of the solid electrolyte layer. In some aspects, electrolyte salt in the solid electrolyte layer may be within a range formed by selecting any two numbers listed in the immediately previous sentence, e.g., between about 0 parts and about 400 parts, or about 60 parts and 400 parts based on the total weight of the solid electrolyte layer.

### Ion Conductivity of the Solid Electrolyte Layer

The solid electrolyte layer can include a suitable reduction stability and/or ion conductivity. Since the solid electrolyte layer mainly functions to transport lithium ions between electrodes, the solid electrolyte layer can include a desirable ion conductivity of at, about, or greater than, 10⁻⁷ S/cm, 10⁻⁶ S/cm, 10⁻⁵ S/cm, or 10⁻⁴ S/cm.

### Thickness of the Solid Electrolyte Layer

A thickness, to, of the solid electrolyte layer can be about 3, 5, 10, 15, 20, 25, 30, 50, 70, 100, 150, 200, 300, 400, 500, or 1,000 μm. In some aspects, the thickness, to, of the solid electrolyte layer may be within a range formed by selecting any two numbers listed in the immediately previous sentence, e.g., between about 5 μm and about 1,000 μm, about 30 μm and about 100 μm, or about 30 μm and about 50 μm.

### Unfinished Product

The cell can be provided as an unfinished product. In some aspects, the cell is stored, transported, and/or delivered to a reseller, customer, or the like that finishes manufacture of a battery assembly or product comprising the cell. In other aspects, the cell is a finished battery assembly or product.

### Seal the Battery

An enclosure of the solid-state battery can be sealed to finish making the solid-state battery such that it will work as a battery. The sealing process may involve various techniques to ensure the internal components are protected from external environmental factors and to maintain the integrity of the battery structure. For example, the enclosure may be hermetically sealed using methods such as laser welding, ultrasonic welding, or adhesive bonding. In some cases, the sealing process may also include the introduction of a protective atmosphere or the removal of air to create a vacuum within the enclosure. This sealing step may be helpful for preventing moisture ingress, which could potentially degrade the performance of the sulfide-based solid electrolyte. Additionally, the sealing process may incorporate safety features such as pressure relief mechanisms to manage any potential gas build-up during battery operation. Once properly sealed, the solid-state battery is ready for final quality control checks, which may include electrical testing, leak detection, and visual inspections. After passing these checks, the solid-state battery could be packaged and sold as a finished product, ready for integration into various electronic devices, electric vehicles, energy storage systems, and so forth.

### Battery Configured

The solid-state battery is provided in various configurations to suit different applications and device requirements. In some aspects, the battery may be manufactured in a cylindrical form, which can be advantageous for certain types of portable electronics or automotive applications. Alternatively, the solid-state battery may be produced in a prismatic form, which can allow for more efficient space utilization in devices with rectangular form factors. In other cases, a pouch form may be employed, offering flexibility in shape and potentially reducing overall battery weight. The pouch form may further be especially suitable for solid state batteries due to easier application and control of uniform pressures within the battery. The choice of configuration may depend on factors such as the intended use, space constraints, thermal management requirements, and manufacturing considerations. In some aspects, hybrid or custom configurations combining elements of different forms may be utilized to meet specific design needs. The versatility in battery form factors can enable the integration of solid-state batteries into a wide range of products, from small wearable devices to large-scale energy storage systems.

### Voltage

The solid-state battery is configured to output a voltage of at or about 1, 2, 3, 4, 5, 6, 10, 12, 20, 24, 30, 40, 48, 50, 60, 70, 80, 90, 96, 100, 200, 300, 400, or 500 V DC. In some aspects, the output voltage of the solid-state battery may be within a range formed by selecting any two numbers listed in the immediately previous sentence, e.g., between about 1 V DC and about 500 V DC.

### Capacity

The solid-state battery is configured to have a specific capacity of at, about, or greater than 100, 110, 120, 130, 140, 150, 160, 170, 180, 190, 200, or 300 mAh/g. In some aspects, the output voltage of the solid-state battery 100 may have a capacity formed by selecting any two numbers listed in the immediately previous sentence, e.g., between about 100 mAh/g and about 300 mAh/g.

### Volume Expansion Calculation

The solid-state battery can include a desirable volume expansion rate. The volume expansion rate may be calculated from an increase amount of thickness after a first cycle of charging and discharging compared to an initial thickness. The volume expansion rate means a ratio of an amount of change in a thickness increased after a first cycle of charging and discharging to an initial thickness of a particular element. A first cycle of charging and discharging is performed by CC-CV charging a battery at 0.1 C and cutting off at 4.25 to 4.4 V and 0.02 C, and CC discharging the battery at 0.1 C and cutting off at 3 V. The volume expansion rate is calculated by Equation 1 below in which A may represent a thickness before charging and discharging and B may represent a thickness after charging and discharging. The thickness may be measured using a Mauser micrometer or a scanning electron microscope (SEM).

$$Volume expansion rate = [ ( B - A ) / A ] \times 100 C - Rate \qquad Equation 1$$

C-rate as used herein refers to the rate at which the battery is discharged relative to its maximum capacity. For example, a 1C rate means the discharge current will discharge the entire battery within one hour. That is, for a battery with a capacity of 20 Amp-hrs, a discharge current at a 1C would be 20 Amps.

Other exemplary ways to measure and calculate the volume expansion rate for a solid-state battery may include using volumetric expansion measurement (e.g., gas pycnometry), in-situ dilatometry, X-ray tomography, strain gauge measurements, optical methods (e.g., digital image correlation or laser interferometry), pressure-based methods, and electrochemical strain microscopy.

### Secondary Battery Characteristics

The battery may comprise a cathode electrode; an anode electrode; and any of the disclosed above electrolytes. In still further aspects, the disclosed battery exhibits a capacity retention of at least about 70% for at least about 300 cycles at a charge/discharge rate of about C/5 to about 1C.

In still further aspects, the battery exhibits a capacity retention of at least about 60%, at least about 65%, at least about 70%, at least about 75%, at least about 80%, at least about 85%, or at least about 90%, for at least about 250 cycles, at least about 300 cycles, at least about 350 cycles, at least about 400 cycles, at least about 450 cycles, at least about 500 cycles, at least about 550 cycles, at least about 600 cycles, at least about 650 cycles, at least about 700 cycles, at least about 750 cycles, at least about 800 cycles, at least about 850 cycles, at least about 900 cycles, at least about 950 cycles, or at least about 1000 cycles at a charge/discharge rate of about C/5 to about 1C, including exemplary values of about C/4, about C/3, about C/2, about 3C/5, about 2C/3, about 3C/4, about 4C/5 (or about C/5 to 4C/5, or C/2 to about 4C/5, or about C/4 to about 2C/3, and so on). It is understood that in certain aspects, the battery can exhibit the disclosed above capacity retention for more than about 1000 cycles, more than about 1500 cycles, or even more than about 5000 cycles when evaluated at the disclosed above conditions.

In still further aspects, the battery exhibits a capacity retention of about 60% to less than or equal to 100%, including exemplary ranges (and any values within the ranges) of about 60% to about 95%, about 70% to about 90%, about 65% to about 99%, and so on, for at least about 250 cycles to about 1000 cycles, including exemplary ranges (and any values within the ranges) of about 250 cycles to about 800 cycles, or about 300 cycles to about 1000 cycles, or about 400 cycles to about 1000 cycles at a charge/discharge rate of about C/5 to about 1C, including exemplary values of about C/4, about C/3, about C/2, about 3C/5, about 2C/3, about 3C/4, about 4C/5 (or about C/5 to 4C/5, or C/2 to about 4C/5, or about C/4 to about 2C/3, and so on).

In still further aspects, the battery can comprise a separator. In such aspects, any known in the art separators that are capable of achieving the desired results can be used. For example, and without limitations, the separators can comprise glass fiber, a porous polymer film (e.g., polyethylene- or polypropylene-based material) with or without a ceramic coating, or a composite (e.g., a porous film of inorganic particles and a binder). One exemplary polymeric separator is a polyethylene (PE) membrane. Another exemplary polymeric separator is a polypropylene (PP) membrane. The separator may be infused with any of the disclosed electrolytes herein.

In still further aspects, the battery comprises an anode, wherein the anode comprises carbon, silicon, Li, Li alloys, Li intermetallics, Li compounds, TiNb₂O₇, Li₄Ti₅O₁₂, or any combination thereof. In still further aspects, the anode electrode comprises a metal current collector serving as a substrate for an anode active material being formed in situ on a first cycling of a battery. In still further aspects, the anode electrode is formed in situ on a bare current collector, where the current collector can comprise any of the disclosed herein materials. In some aspects, such a battery can be referred to as anodeless configuration.

It is understood that similar electrolytes can be used in potassium or sodium anode-based batteries, wherein the salts are exchanged for salts containing potassium of sodium cations.

In still further aspects, the cathode present in the battery can be a metal cathode or a composite cathode. In yet further aspects, the cathode comprises layered oxide cathodes, vanadium-based cathodes, sulfur-based cathodes, manganese-based cathodes, rocksalt cathode, disordered rocksalt cathode, lithium-rich cathode, NMC (nickel-manganese-cobalt oxide) cathode, NCA (nickel-cobalt-aluminum oxide) cathode, NFM (nickel-iron-manganese oxide) cathode, LCO (lithium-cobalt oxide) cathode, LFP (lithium iron phosphate) cathode, fluoride-based cathode, sulfur selenium cathode, sulfur cathode, selenium cathode, tellurium cathode, spinels cathode, olivines cathode, or any combination thereof.

Yet in still further exemplary and unlimiting aspects, the cathode active material can comprise a high density nickel-rich layered transition metal oxide (Li[NiₓMn_{y}Co_{z}]O₂ (x+y+z=1)), a lithium iron phosphate (LFP), lithium manganese oxide (LiMn₂O₄), or nickel-doped lithium manganese oxide (Li[Ni_{0.5}Mn_{1.5}]O₄).

In still further aspects, the cathode composite material can comprise additional components. For example, and without limitations, in some aspects, the cathode composite material can comprise one or more fillers. In such exemplary aspects, the one or more fillers can comprise conductive fillers, flame retardants, flame-resistant agents, stabilizers, antibacterial agents, or any combination thereof. For example, and without limitations, the one or more filler can comprise a carbon black, a modified carbon black, a graphene, multi-layer graphene, carbon fibers, carbon nanotubes, carbon nanospheres, graphite, a reduced graphene oxide, or any combination thereof. Yet in still further aspects, the cathode can comprise binders such as polyvinylidene fluoride (PVDF), poly(ethylene oxide), cellulose, carboxymethylcellulose (CMC), a polytetrafluoroethylene (PTFE), styrene-butadiene rubber (SBR), polyacrylic acid (PAA), polyvinyl alcohol (PVA), polyvinyl butyral (PVB), polyvinylpyrrolidone (PVP), ethyl cellulose (EC), copolymers thereof, or any combination thereof.

Yet, in still further aspects, the fillers are those that do not negatively affect the ionic conductivity or stability of the cathode composite material.

In still further aspects, the battery exhibits a Coulombic efficiency greater than about 80%, greater than about 85%, greater than about 90%, greater than about 95%, greater than about 99% over at least about 100 cycles, at least about 200 cycles, at least about 300 cycles, at least about 400 cycles, at least about 500 cycles, at least about 600 cycles, at least about 700 cycles, at least about 800 cycles, at least about 900 cycles, or at least about 1000 cycles.

In still further aspects, the battery exhibits a coulombic efficiency no less than about 99.9%, no less than about 99%, no less than about 95%, no less than about 92%, no less than about 90%, no less than about 85%, or no less than about 80% for at least about 100 cycles, at least about 200 cycles, at least about 300 cycles, at least about 400 cycles, at least about 500 cycles, at least about 600 cycles, at least about 700 cycles, at least about 800 cycles, at least about 900 cycles, or at least about 1000 cycles. In still further aspects, the coulombic efficiency can be in a range of about 80% to about 100%, including exemplary values of about 85%, about 90%, about 95%, about 99%, and about 99.99% for at least about 100 cycles, at least about 200 cycles, at least about 300 cycles, at least about 400 cycles, at least about 500 cycles, at least about 600 cycles, at least about 700 cycles, at least about 800 cycles, at least about 900 cycles, or at least about 1000 cycles. In still further aspects, the coulombic efficiency can have any value that falls between any two foregoing values, or it can be present in any range that is formed by any of the foregoing values. For example, the coulombic efficiency can be about 80% to about 100%, or about 80 to about 99%, or about 80% to about 95%, and so on. In still further aspects, such a coulombic efficiency can be demonstrated for at least about 100 cycles, or about 100 cycles or more, for about 200 cycles or more, for about 500 cycles or more, for about 1000 cycles or more, for about 2000 cycles or more, for about 5000 cycles or more, 10000 for about 100 cycles or more, or even 100000 or more.

In still further aspects, the batteries disclosed herein are configured to operate in a temperature range of about −30° C. up to about 60° C., including exemplary values of about −25° C., about −20° C., about −15° C., about −10° C., about −5° C., about 0° C., about 25° C., about 30° C., about 35° C., about 40° C., about 45° C., about 50° C., and about 55° C. In still further aspects, the batteries can operate at a temperature having any value that falls between any two foregoing values, or it can be present in any range that is formed by any of the foregoing values. For example, and without limitations, the battery can operate at a temperature of about −25° C. up to about 60° C., about −15° C. up to about 60° C., about −10° C. up to about 60° C., about −5° C. up to about 60° C., about −15° C. up to about 50, about −15° C. up to about 40° C., about 0° C. up to about 60° C., about 5° C. up to about 60° C., about 20° C. up to about 60° C., about 20° C. up to about 50° C., about 20° C. up to about 40° C., and so on.

In still further aspects, the battery exhibits a capacity retention of at least about 10%, at least about 20%, at least about 30%, at least about 40%, at least about 50%, at least about 60%, at least about 70% or at least about 80% higher than a capacity retention of a reference battery comprising substantially identical cathode material comprising nickel-manganese-cobalt oxide, anode material, and a separator, and comprises an electrolyte comprising about 1M LiPF₆ in EC:DMC:DEC (about 1:1:1 vol ratio).

In still further aspects, the battery exhibits a specific discharge capacity of about 50 mA h/g to about 300 mA h/g when discharged at about 0.1C to about 10C rate. In yet other aspects, the battery exhibits a specific discharge capacity of about 50 mA h/g or more, about 75 mA h/g or more, about 100 mA h/g or more, about 120 mA h/g or more, about 150 mA h/g or more, about 175 mA h/g or more, about 200 mA h/g or more, about 225 mA h/g or more, about 250 mA h/g or more, about 275 mA h/g or more. Yet in other aspects, the battery exhibits a specific discharge capacity of about 300 mA h/g or less, about 275 mA h/g or less, about 250 mA h/g or less, about 225 mA h/g or less, about 200 mA h/g or less, about 175 mA h/g or less, about 150 mA h/g or less, about 125 mA h/g or less, about 100 mA h/g or less, or about 75 mA h/g or less. In still further aspects, the battery exhibits a specific discharge capacity of about 50 mA h/g to about 300 mA h/g, including exemplary values of about 50 mA h/g, about 75 mA h/g, about 100 mA h/g, about 125 mA h/g, about 150 mA h/g, about 175 mA h/g, about 200 mA h/g, about 225 mA h/g, about 250 mA h/g, and about 275 mA h/g. In still further aspects, the battery exhibits a specific discharge capacity that can have any value that falls between any two foregoing values, or it can be present in any range that is formed by any of the foregoing values. For example, the battery exhibits a specific discharge capacity of about 50 mA h/g to about 300 mA h/g, about 50 mA h/g to about 200 mA h/g, about 50 mA h/g to about 100 mA h/g, about 75 mA h/g to about 300 mA h/g, about 100 mA h/g to about 300 mA h/g, and so on. In still further aspects, the battery exhibits the disclosed above specific discharge capacity when discharged at about 0.05C to about 20C rate. In such aspects, the discharge rate can be about 0.1 C, about 0.2C, about 0.3C, about 0.4C, about 0.5C, about 1C, about 2C, about 4C, about 5C, about 6C, about 7C, about 8C, about 9 C, about 10 C, about 11 C, about 12 C, about 13 C, about 14 C, about 15 C, about 16 C, about 17 C, about 18 C, and about 19 C. In still further aspects, the discharge rate can have any value that falls between any two foregoing values, or it can be present in any range that is formed by any of the foregoing values. For example, the discharge rate can be about 0.05C to about 20C rate, about 0.1C to about 20C rate, about 0.1C to about 10C, about 0.5C to about 20C rate, rate about 0.2C to about 10C rate, about 0.5C to about 8C rate, about 2C to about 10C rate, about 4C to about 10C rate and so on.

Also disclosed herein are systems comprising one or more of any of the disclosed herein batteries. For example, the system can comprise at least about 2, at least about 5, at least about 10, at least about 50, at least about 100, at least about 500, or at least about 1000 batteries.

Also disclosed herein are articles that can comprise the disclosed herein batteries or systems. For example, the article can comprise a vehicle (land, marine, air, or space-adapted vehicles), a hand-held device, a wearable electronic device, stationary electronic devices, electrical tools, toys, energy storage devices, and the like.

### EXAMPLES

The following examples are not intended to be limiting. The above disclosure provides many different aspects for implementing the features of the disclosure, and the following examples describe certain aspects. It will be appreciated that other modifications and methods known to one of ordinary skill in the art may also be applied to the following experimental procedures, without departing from the scope of the disclosure.

### Experiment 1

Electrolyte compositions according to disclosed aspects, or additive-containing electrolytes (ACE) were compared with conventional ether electrolytes (CEE) as follows.

### Electrolyte and Electrode Preparation

For the ether electrolytes, 1M lithium bis(fluorosulfonyl)imide (LiFSI, Solvionic) was dissolved in anhydrous tetrahydrofuran (THF, Sigma-Aldrich). Tetrabutylammonium tetrafluoroborate (TBATFB, Sigma-Aldrich) were processed using the following protocols to remove any excess water. After vacuum drying in 80° C. for 48 hours, TBATFB was dissolved in THF and then refluxed in Argon environment for 2 hours. The salt was subsequently recrystallized in anhydrous ethyl acetate (Sigma-Aldrich) to obtain white crystals. Then, 0.1 M (Example 1), 0.5 M (Example 2), and 1.0 M (Example 3) concentrations of TBATFB were added to the 1 M LiFSI/THF electrolytes. A control solution of 1 M LiFSI/THF electrolytes with no TBATFB added was also established (Comparative Example 1). The LiFePO₄ (LFP, MSE Supplies) and single crystal LiNi_{0.88}Co_{0.09}Al_{0.03}O₂(NCA-88, MSE Supplies) cathodes were prepared using a slurry cast method. Initially, a slurry was created by mixing the active material, Super P carbon black, and Polyvinylidene fluoride (PVDF) binder (MSE Supplies) in a mass ratio of 90:5:5 in anhydrous N-methyl pyrrolidone (NMP, Sigma-Aldrich). The slurry was then casted using a doctor blade method onto aluminum foil and punched into 13 mm disks. Subsequently, the cathodes were pressed with roll press at 90° C. The electrodes underwent vacuum drying for at least 24 hours at 65° C. prior to cell assembly.

### Electrochemical Characterization

All tests were conducted using 2032-type coin cells assembled in an Argon-filled glovebox (MBRAUN, O₂ and H₂O<0.1 ppm) with polypropylene (Celgard 2325) as the separator. Li∥Li symmetric cells and Li∥Cu asymmetric cells were assembled using a 250 μm Li chip as the reference and counter electrode. The exchange current density was determined using the Tafel plot and the Butler-Volmer equation. To generate a Tafel plot, the Li∥Li cell was scanned at a constant rate of 0.5 mV s₋₁ within a voltage range of −0.2 and 0.2 V vs. Li/Li₊. The overpotentials needed for the Butler-Volmer equations were obtained through galvanostatic charge/discharge of Li∥Li cells, using currents ranging from 20 to 100 μA. The passivation stability of the Li metal anode was assessed by setting up a Li∥Cu cell at 0 V vs. Li/Li+ and monitoring the leakage current for 10 hours. Calendar ageing of Li was performed by initially plating and stripping 5 mAh cm₋₂ of Li, followed by another plating 5 mAh cm₋₂ of Li. The cells were then allowed to rest for 0, 1, and 5 days before being stripped to 1 V vs. Li/Li+. Li∥LFP full cell batteries were tested using a 35-μm thick Li anode and a 4 mAh cm₋₂ loading LFP cathode, within a voltage range of 2.5-4.0 V vs. Li/Li₊. Li∥NCA-88 full-cell batteries were tested using either a 35-μm-thick or 50-μm-thick Li anode, coupled with a 2 mAh cm₋₂ or 4 mAh cm₋₂ NCA-88 cathode, within the voltage range of 2.7-4.3 V vs. Li/Li₊. Anode-free Cu∥NCA-88 cells were assembled using Cu foil as the anode and a 2 mAh cm₋₂ NCA-88 cathode within the same voltage range. Electrochemical floating test was performed by placing a Li∥NCA-88 cell at 4.3 V vs. Li/Li₊ and measuring the leakage current. Galvanostatic Intermittent Titration Technique (GITT) was performed by charging and discharging at 0.02 C with 45-minute rest intervals. Electrochemical impedance spectroscopy (EIS) experiments were carried out from 10₋₂ Hz to 10₅ Hz using a 10-mV peak voltage at open-circuit voltage. The ionic conductivity and transference number of the electrolytes were measured using EIS with SS∥SS and Li∥Li symmetric cells, respectively. The transference number was determined using the Bruce-Vincent method with a polarization voltage and time of 10 mV and 2 hours. Identical conditions were used for measuring the total impedance of Li∥Li and Li∥NCA-88 full cells. BioLogic VMP3 and Arbin battery cyclers were used for all electrochemical analysis.

### Materials Characterization

The morphology of the Li metal deposits was examined using scanning electron microscopy (SEM, SU-8230). The electrolyte's solvation structure was analyzed using Raman Spectroscopy (Renishaw Qontor Dispersive Raman Spectrometer). The chemical composition of the SEI and CEI was investigated using X-ray photoelectron spectroscopy (Thermo Scientific K-alpha XPS instrument) with air-tight transfer. High-resolution XPS of Li Is, C 1s, O 1s, F 1s, and S 2p spectra were fitted using XPSPEAKS 4.1. One-dimensional ₇Li, ₁₉F {₁H} and ₁₇O NMR spectra were recorded on a Bruker AVANCE III HD 14.1 T (ω_{1H}=600 MHz) spectrometer using a BB Prodigy CryoProbe. All spectra were internally referenced by adding a glass capillary containing an appropriate reference solution: ₇Li NMR spectra were referenced to LiCl (1 M in D₂O) at 0.0 ppm, ₁₉F NMR spectra were referenced to LiPF₆ (1 M in EC/DMC; 1:1 v/v) at −74.5 ppm (δ ₁₉F), and ₁₇O spectra were referenced to D₂O at 0.0 ppm.

### Computational Details

The Vienna ab-initio simulation package (VASP) was employed for conducting density functional theory (DFT) computations. The projector augmented wave (PAW) approach was utilized for core electron representation, and the determination of the exchange-correlation functional relied on the Perdew-Burke-Ernzerhof (PBE) method within the framework of the generalized gradient approximation (GGA). A plane-wave cutoff energy of 400 eV was selected and an energy convergence threshold of 10₋₅ eV was enforced, and computations were continued until atomic forces diminished to below 0.02 eV Å₋₁. For the optimization of molecular adsorption structures, the Brillouin zone in reciprocal space using a 1×1×1 k-point grid was integrated, and a 1× 1× 1 k-point grid for ab-initio molecular dynamics (AIMD) calculations to enhance computational speed was utilized. Spin polarization was considered in all calculations except for AIMD simulations. The Li (100) surface was modeled with a 6×6 supercell containing 3 layers, with the bottom two layers fixed to represent the bulk region. For surface AIMD calculations, 50,000 steps were performed with a time step of 1 fs under the condition of 300K temperature. To prevent interactions due to periodic boundary conditions during relaxations involving molecules and surfaces, a vacuum of at least 15 Å was included. For computing solvation structures in the electrolytes, the universal graph deep learning interatomic potential (M3GNet) for fast computations was employed. The conventional ether electrolyte was modeled with 5 LiFSI and 60 THF molecules, while the electrolytes according to disclosed aspects (Examples 1-3) included an additional TBATFB in addition to CEE. Molecular dynamics simulations for observing electrolyte solvation structures were performed for 30 ps at a temperature of 350 K.

### Electrolyte Evaluation and Optimization

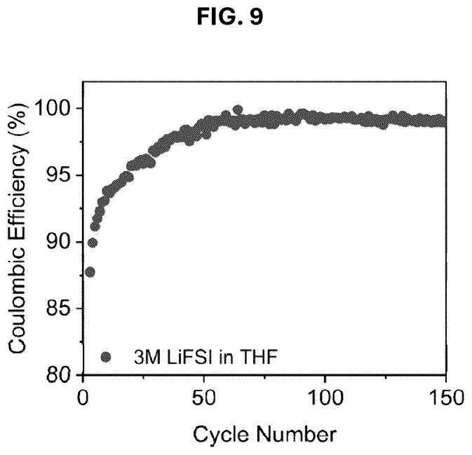

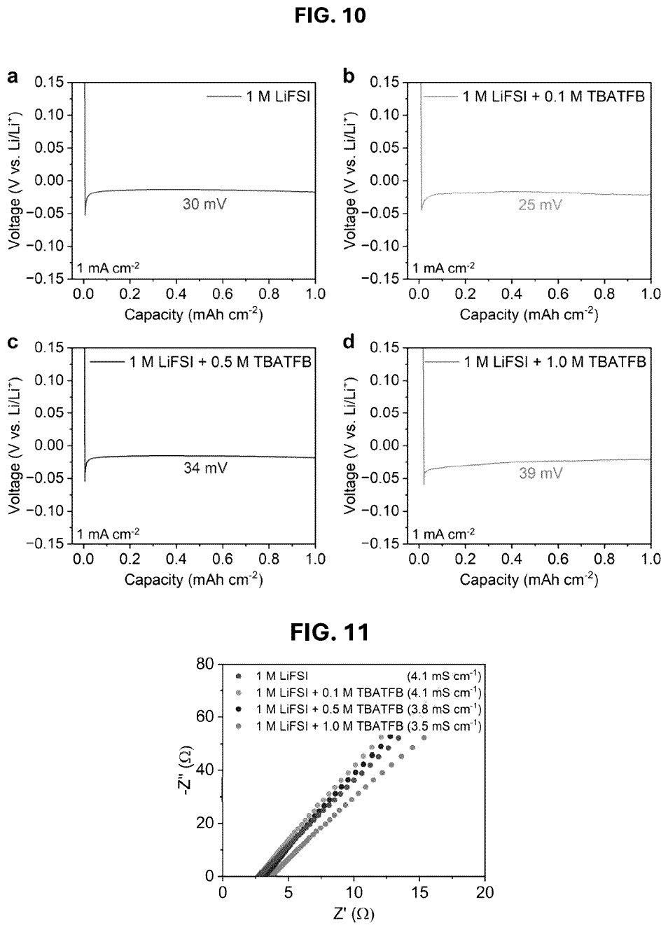

The optimization process was initiated by adjusting the concentration of the fluorinating additive to enhance compatibility between the electrolyte and the LMA. Li reversibility was evaluated through a Li plating/stripping process on a copper (Cu) substrate, conducted at a current density of 1 mA cm⁻² and an areal capacity of 1 mAh cm⁻² for 300 cycles (FIG. 8). The addition of TBATFB enhanced LMA stability, as evidenced by Coulombic efficiencies (CEs) exceeding 99%, compared to 97.8% efficiency observed in ether electrolytes. The trend remained consistent when electrolytes were tested using the modified Aurbach protocol (FIG. 9). It is noteworthy that the gradual increase in CEs for 1M LiFSI+1M TBATFB in THF up to the 50th cycle is attributed to the high salt concentration, a trend paralleled with the 3M LiFSI high-concentration electrolyte (HCE) (FIG. 9). At 1 mA cm⁻², the 0.1M TBATFB-added electrolyte exhibited the lowest initial Li nucleation overpotential of 25 mV (FIG. 10). A lower nucleation overpotential is advantageous as it thermodynamically favors the formation of larger Li nuclei, resulting in a compact Li deposition morphology. The ionic conductivity and Li selectivity of these electrolyte systems was further analyzed.

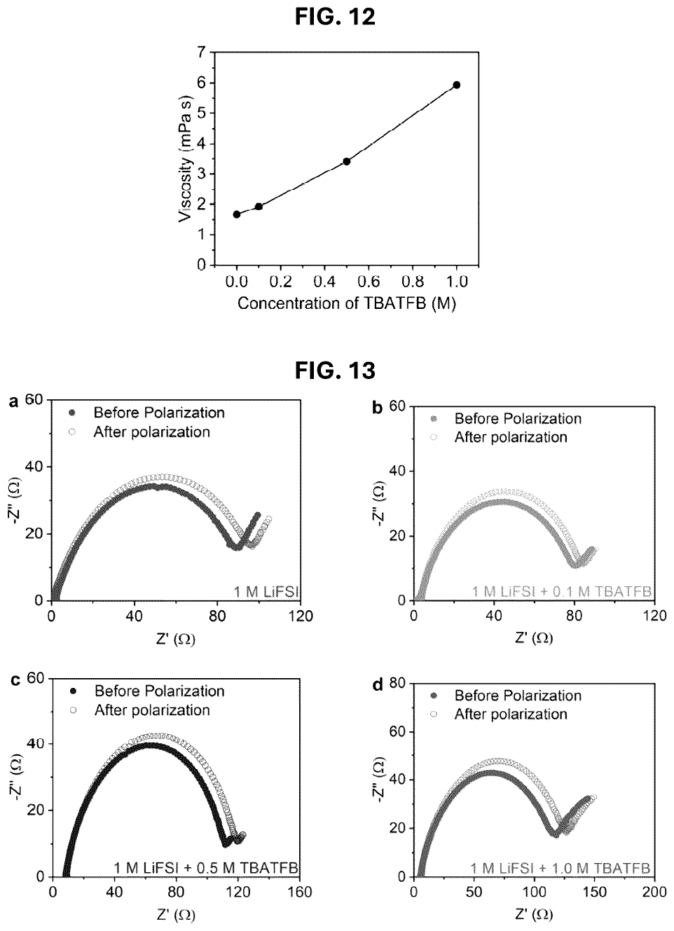

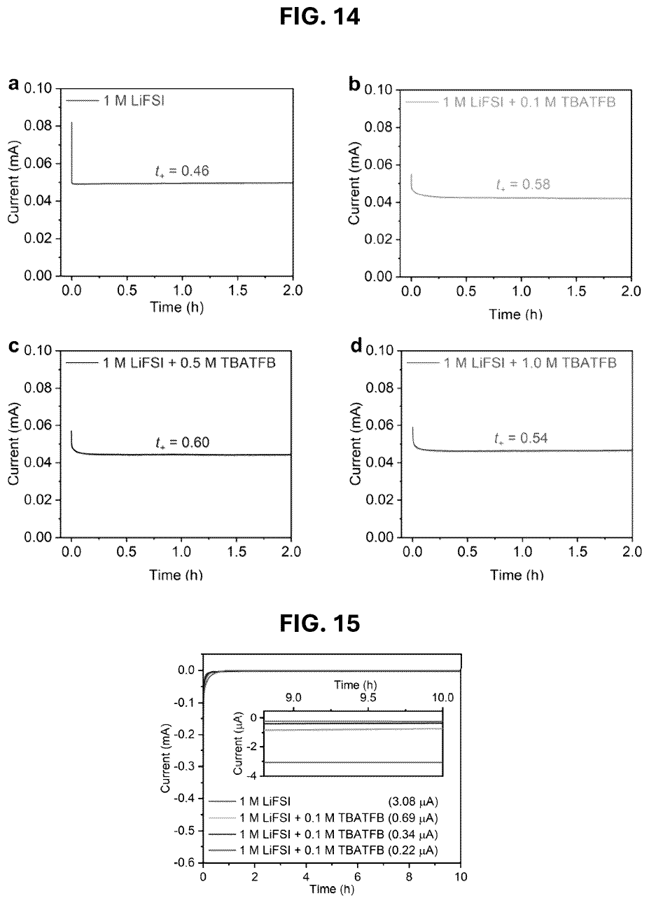

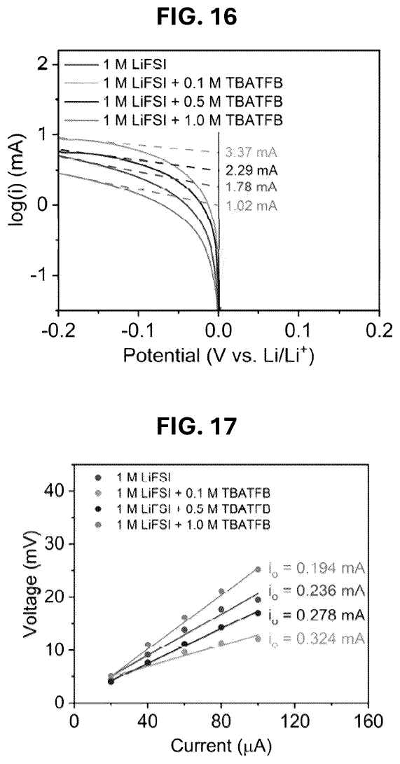

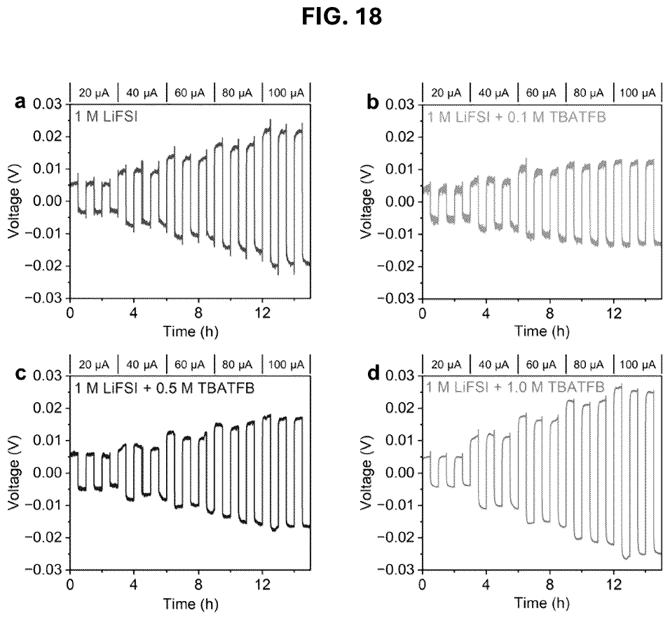

The addition of TBATFB generally resulted in reduced ionic conductivity, except at 0.1M TBATFB, which showed negligible change compared to the ether electrolyte (FIG. 11). Electrolyte viscosities increased with increasing TBATFB concentrations, indicating reduced ion mobility within the electrolyte (FIG. 12). An increase in Li+ transference number was observed with the addition of TBATFB (FIG. 13 and FIG. 14), attributed to attractive Coulomb interactions between TBA⁺ cations and FSI⁻ and BF₄⁻ anions that enhance cationic selectivity. Next, Li passivation stability was assessed by measuring leakage current in a Li∥Cu asymmetric cell at 0 V vs. Li/Li+ (FIG. 15). Low leakage currents (below 1 μA) underscored the increased stability of the SEI due to TBATFB additives. Exchange current densities of the electrolytes were measured using two methods: extrapolating the Tafel plot and applying the Butler-Volmer equations at low overpotentials (FIG. 16, FIG. 17, and FIG. 18), both exhibiting parallel trends. In both methods, the 0.1M and 0.5M TBATFB additive demonstrated improved electrochemical activity compared to the ether electrolyte.

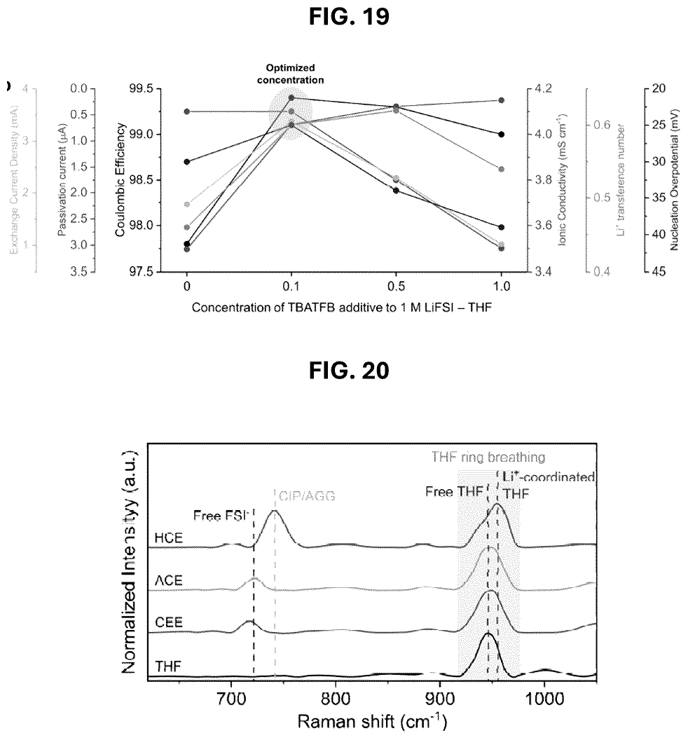

To optimize the additive-engineered electrolyte, key parameters including exchange current density, passivation stability, CE, ionic conductivity, transference number, and nucleation overpotential across different additive concentrations were compared. As seen in FIG. 19, Example 1 (1 M LiFSI/THF+0.1 M TBATFB) exhibited superior exchange current density, passivation current, coulombic efficiency, ionic conductivity, Li⁺ transference number, and nucleation overpotential compared to Comparative Example 1 (no TBATFB) and Example 2 (1 M LiFSI/THF+0.5 M TBATFB) and Example 3 (1 M LiFSI/THF+1 M TBATFB). These results show that the optimal molar ratio of LiFSI/THF to TBATFB in the electrolyte solution is about 1:0.1.

### Electrolyte Solvation Structure

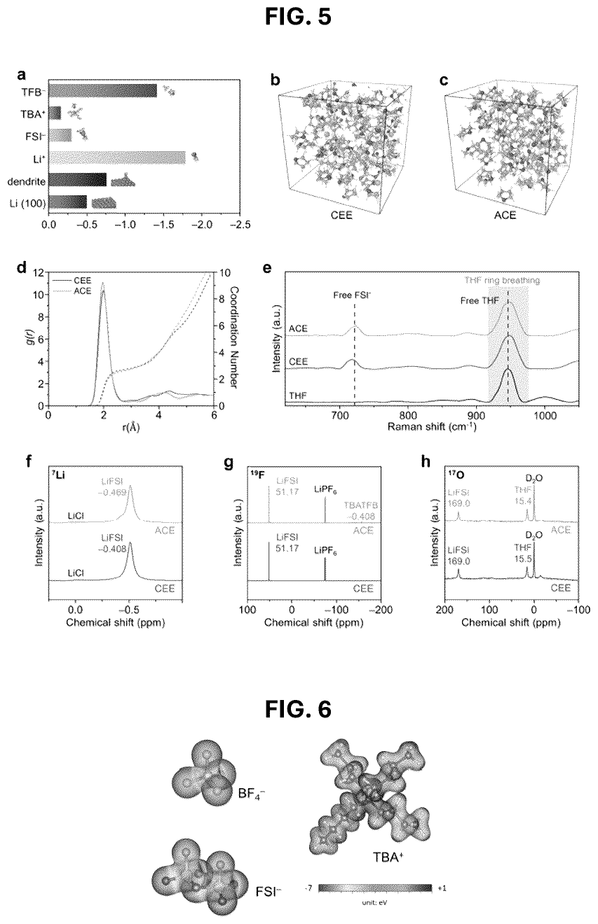

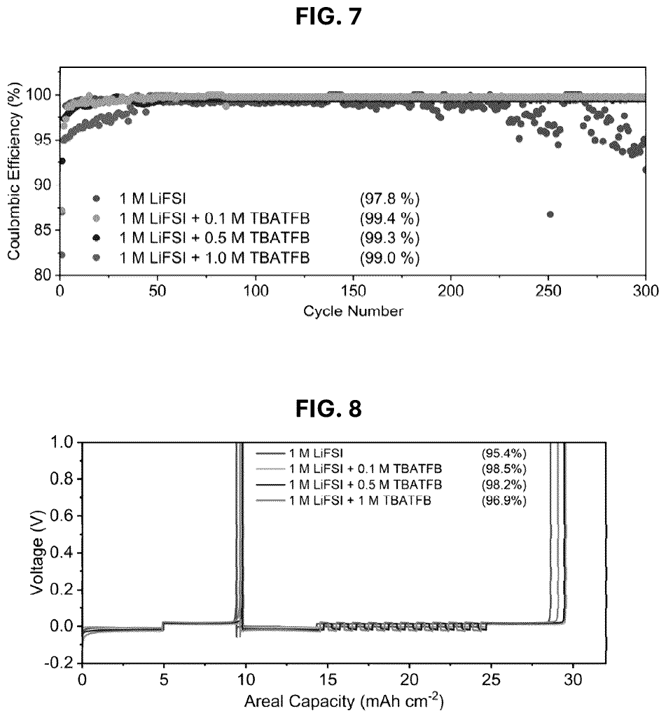

The solvation structures of ACE (Example 1) were compared with CEE (Comparative Example 1). Firstly, density functional theory (DFT) computations were applied to verify the binding of TBATFB with THE solvent molecules (FIG. 5a and FIG. 6) Next, molecular dynamics (MD) simulations provided further insights into the molecular interactions within the solvation shells (FIG. 5a and FIG. 5c). Both CEE and ACE displayed a distinctive SSIP structure, characterized by Li+ coordination largely dominated by solvent molecules (FIG. 5d). The coordination dynamics of Li+ with THE solvents in these electrolyte systems was obtained through Raman spectroscopy (FIG. 5e). The peaks of free THF (948 cm⁻¹) and free FSI⁻ (719 cm⁻¹) remained at identical positions for CEE and ACE. The peak associated with CIP/AGG (742 cm⁻¹) and Lit-coordinated THE peak (955 cm⁻¹) observed in HCE were not present in either CEE or ACE (FIG. 20). These results indicate that the presence of TBATFB did not alter the electrolyte solvation structure. Nuclear magnetic resonance experiments were conducted to verify equivalent local environments in CEE and ACE. The 7Li NMR spectra showed a negligible change in the 7Li signal (δ(7Li)=−0.408 ppm for the CEE, compared to δ(7Li)=−0.469 ppm for the ACE), indicating similar Li+ binding energies within CEE and ACE (FIG. 5f). The 19F NMR spectra revealed that the local environment of the FSI⁻ is highly similar in both electrolyte solutions (δ(19F)=51.17 ppm for both the CEE and ACE, while the characteristic BF4⁻ peak is exclusively present in the ACE (δ(19F)=−156.35 ppm; FIG. 5g). This is further supported by the 17O NMR spectra (FIG. 5h). The 17O NMR signal for LiFSI is identical in both electrolyte solutions (δ(17O)=169.0 ppm). The marginal change in the 17O NMR signal for THF (δ(17O)=15.5 ppm for CEE, compared to δ(17O)=15.4 ppm for ACE) suggests that the local coordination environment of the solvent molecules is analogous in both electrolyte solutions.

### Enhanced Li Metal Stability

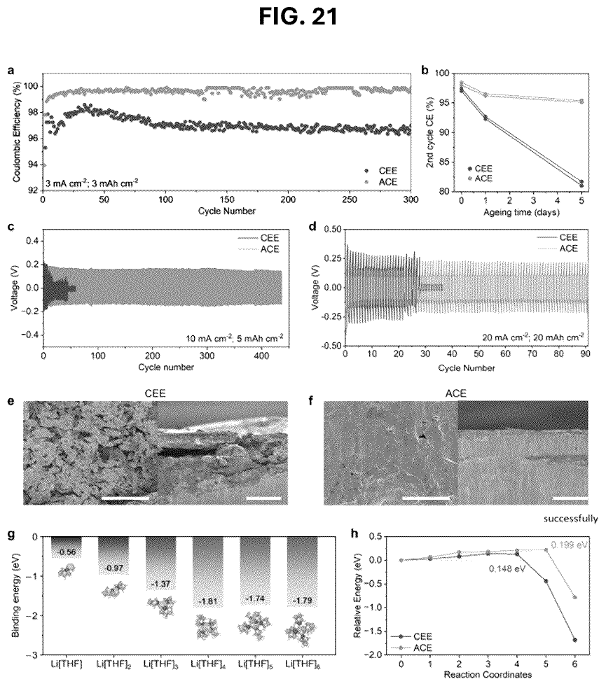

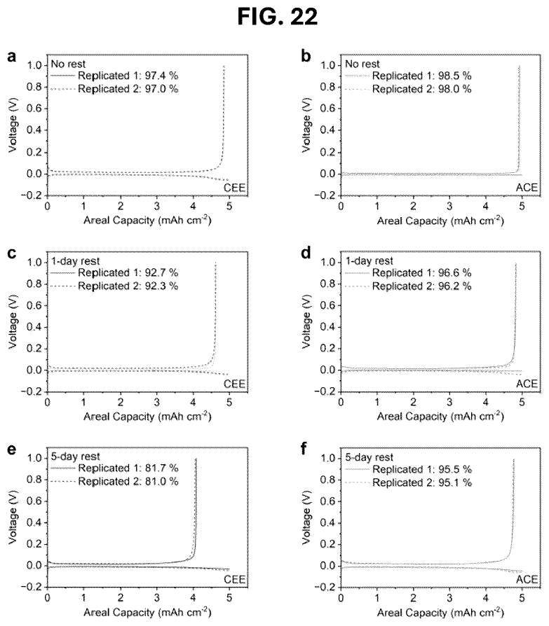

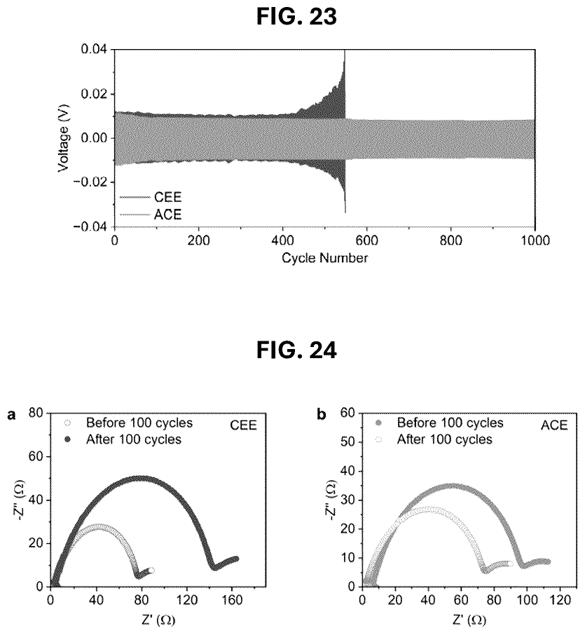

Li reversibility was investigated by evaluating the CEs of Li∥Cu asymmetric cells under heightened current densities and capacities of 3 mA cm-2 and 3 mAh cm-2, respectively (FIG. 21). The average CEs for CEE and ACE were 97.0% and 99.2%, respectively. LMA corrosion during calendar ageing was assessed after 0, 1, and 5 days of ageing (FIG. 21b and FIG. 22). CEE exhibited a relatively linear decrease in CEs with ageing time, while ACE displayed stabilized capacity loss, indicating its self-passivating behavior. To assess LMA stability, Li∥Li symmetric cells were tested under high current densities and areal capacities of 10 mA cm-2 and 4 mAh cm-2 (FIG. 21c) and 20 mA cm-2 and 20 mAh cm-2 (FIG. 21d). Under both conditions, the cells cycled with CEE shorted during early cycles, while ACE showed stable and prolonged cycling performance. ACE also demonstrated stable cycling stability for 1000 cycles at a milder regime of 1 mA cm⁻² and 1 mAh cm⁻² (FIG. 23). To decipher underlying failure mechanisms, Li∥Li symmetric cells were cycled under 1 mA cm⁻² and 1 mAh cm⁻² for 100 cycles and subjected to analysis. Scanning electron microscopy (SEM) images showed mossy and dendritic Li with porous deposits in CEE, contrasting with dendrite-free densely packed morphology in ACE (FIG. 21e and FIG. 21f). Electrochemical impedance spectroscopy revealed a significant impedance increase from 77 to 141Ω in CEE (FIG. 24). Conversely, ACE showed a modest increase from 75 to 95Ω, suggesting the formation of a thin and robust SEI. The dendrite suppression mechanism of ACE was investigated by measuring the potential energy as a solvated Lit ion was deposited on the LMA surface (FIG. 2). DFT calculations revealed that within one to six THF molecules per Li⁺, Li[THF]₄⁺ (−1.81 eV) was the most probable solvation structure (FIG. 21g). The potential energy barrier of 0.148 eV for CEE can be attributed to the de-solvation of THE molecules upon Li deposition (FIG. 21h). The sharp decrease in potential energy at the final reaction coordinates indicates thermodynamically favored Li deposition. On the other hand, nudged elastic band (NEB) calculations unveiled an increased energy barrier of approximately 0.199 eV for Li⁺ for ACE, suggesting a shielding effect by the TBA⁺ cation layer. Typically, dendrite growth is facilitated by three-dimensional (3-D) diffusion of Li⁺ ions due to increased electric field concentrations at preexisting dendrites, a phenomenon often referred to as the ‘tip effect’. As TBA⁺ cations tend to accumulate near 3-D protrusion, the increased energy barrier in ACE limits Li⁺ flux on dendrites, effectively mitigate dendrite growth and promoting uniform, compact Li deposition.

### Characterization of the SEI on Cycled Li Metal Anode

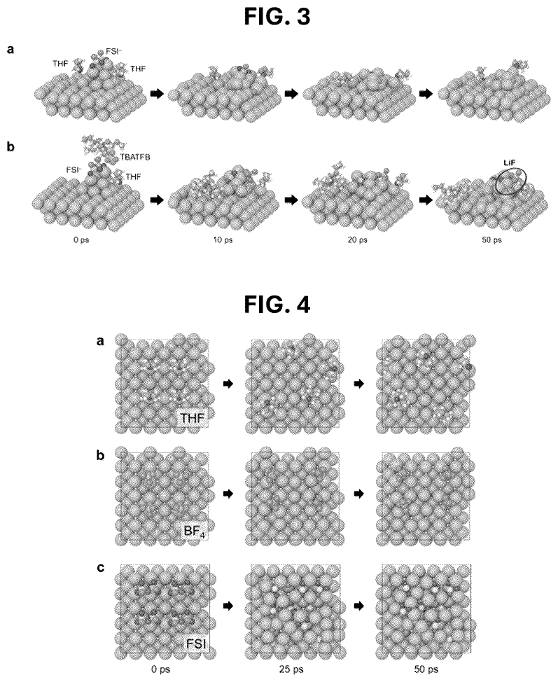

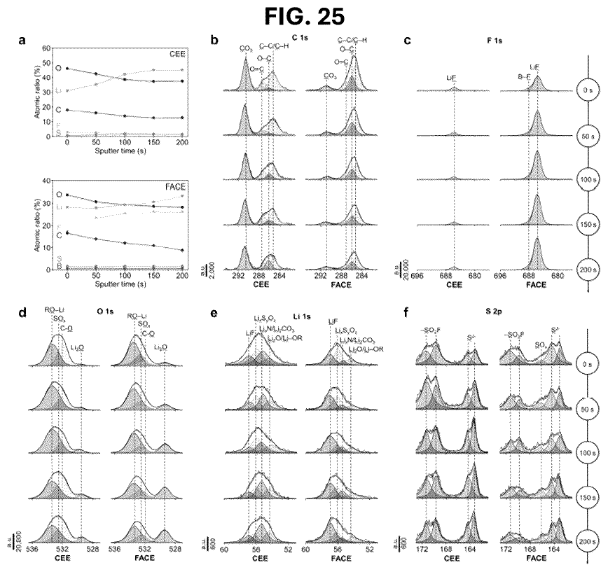

The chemical composition of the SEI was analyzed using X-ray Photoelectron spectroscopy (XPS) complemented by Ar+ sputtering depth profiling (FIG. 25a). XPS elemental analysis revealed a consistent decrease in carbon content in both electrolyte systems upon etching, indicating the formation of SEI with organic-rich outer layer and inorganic-rich inner layer. Specifically, Li₂CO₃ (290.5 eV) was identified as a predominant carbon species on the LMA cycled in CEE (FIG. 25b), consistent with other low-concentration ether electrolytes. The significant presence of Li₂CO₃ is often associated with SEI instability due to its tendency to decompose into gaseous byproducts. In the case of the SEI with ACE, participation of BF4− anions during SEI formation were evident, as highlighted by the distinctive B—F (688.1 eV) and Li—F (684.8 eV) peaks in the F 1s spectra (FIG. 25c). The lithium alkyl oxides (RO—Li, 533.0 eV, O 1s) and the C—O (286.0 eV, C 1s) peaks suggests free THF solvent decomposition (FIG. 25d). Conversely, the SEI with ACE revealed a pronounced Li₂O (529.3 eV) peak, which is known to enhance Li⁺ diffusion within the SEI. The peak intensities in the Li Is spectra were in good agreement with the peaks shown in the C 1s, O 1s, and F 1s spectra (FIG. 25e). In the S 2p spectra, ACE exhibited lower levels of SO2F (169.6 and 171.2 eV) compared to that with CEE but presented a new SOx (166.2 eV) peak, indicating more extensive decomposition of FSI−(FIG. 25f). The fluorination behavior was verified using MD simulations, wherein we observed rapid decomposition of BF₄⁻ at the LMA surface, attributed to its susceptibility to reduction (FIG. 3). It should be noted that a pronounced distortion in the (100) plane of the Li crystalline lattice was detected upon FSI− anion decomposition (FIG. 4). In contrast, BF₄⁻ anions fluorinated the LMA while preserving the Li lattice structure due to its stronger bond strength compared to FSI⁻.

### High Energy Li Metal Batteries

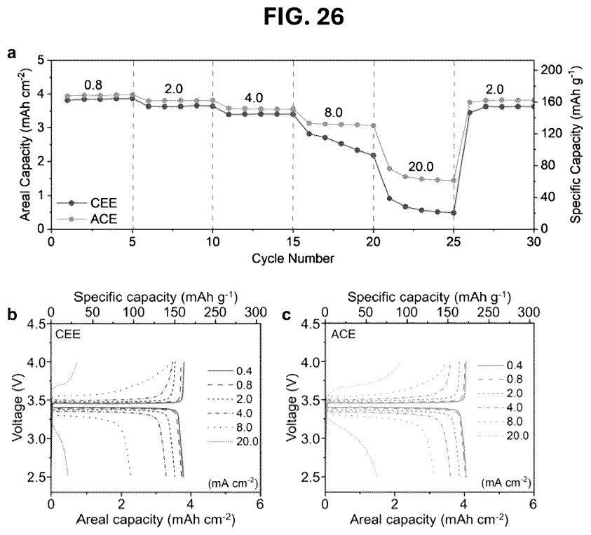

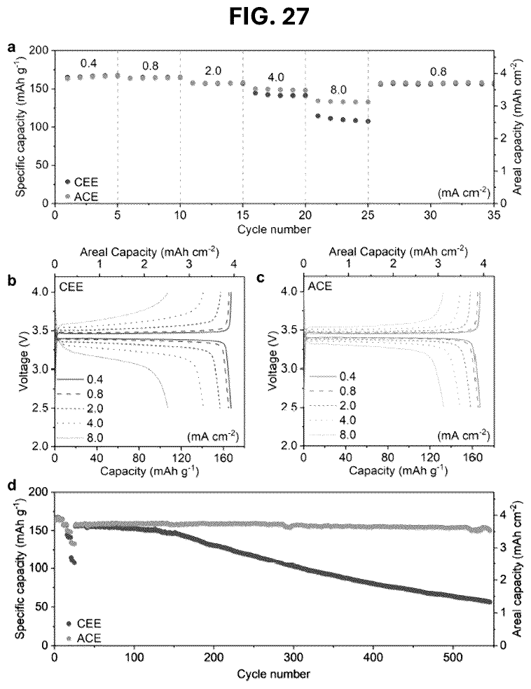

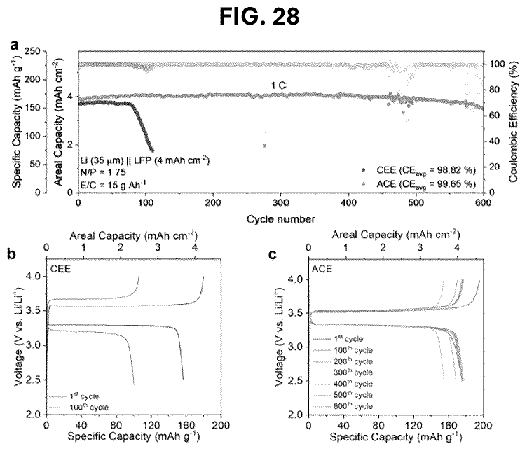

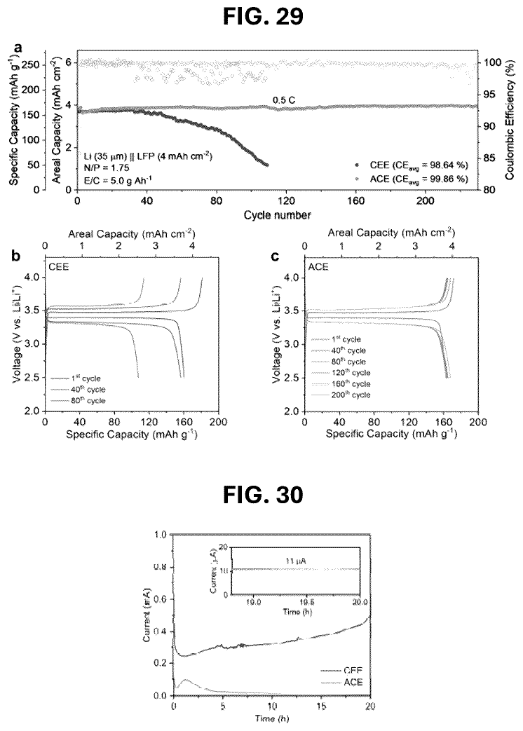

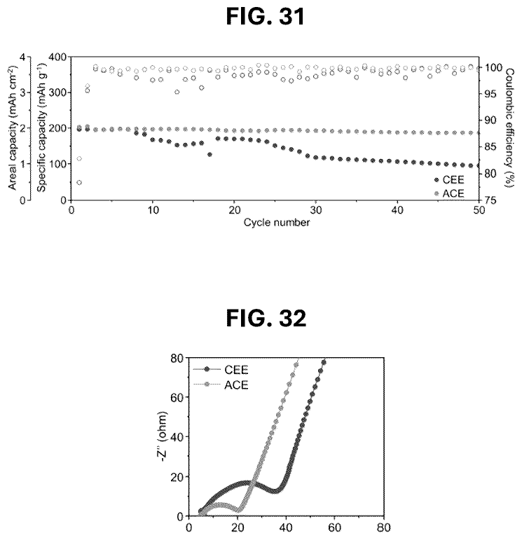

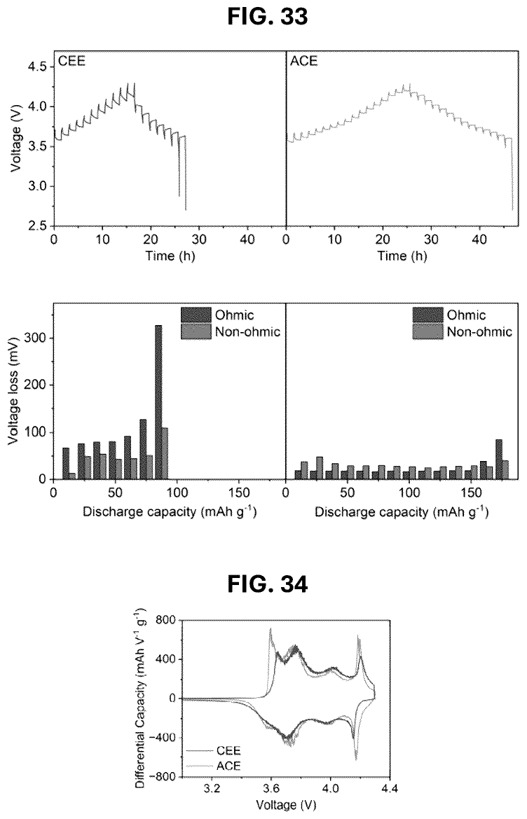

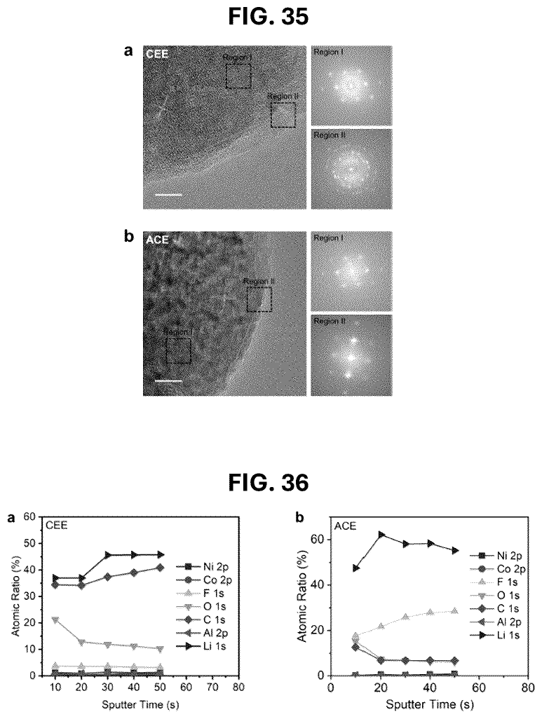

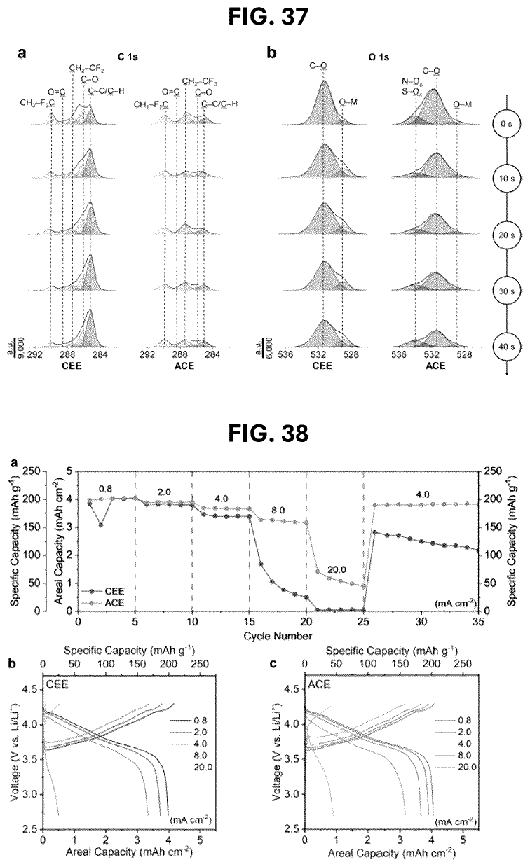

Rate capability tests of the 4 mAh cm⁻² loading-LiFePO₄ (LFP) cathodes were conducted using CEE and ACE, with current densities varying from 0.8 to 20 mA cm⁻² (FIG. 26). At a high current of 20 mA cm⁻², ACE retained nearly three times the capacity compared to CEE. Upon returning the rate to 2 mA cm⁻², both electrolytes showed a recovery of over 99% of their initial capacities. The high-capacity recovery in CEE suggests that the reduced capacity observed at higher current densities is predominantly due to the limited charge transport kinetics at the electrode-electrolyte interphases. The enduring effects of high-rate cycling on LFP capacity retention were further examined (FIG. 27). After returning to lower current densities, CEE exhibited a progressive capacity decrease, eventually dropping to 50% of its initial capacity within 400 cycles. In contrast, ACE demonstrated 98.5% capacity retention after 500 cycles. Given the excess Li and electrolyte used in half-cell configurations, the observed differences are likely associated with the increased impedance in the CEE system. The electrolyte systems under more realistic conditions were then evaluated by fabricating full cells, comprising 35 μm Li with 4 mAh cm⁻² loading cathodes. Cycling at 1C, the Li∥LFP cell with ACE exhibited a remarkable 91% capacity retention after 600 cycles, while that with CEE failed within 80 cycles (FIG. 28). When the electrolyte (E/C=5.1 g Ah⁻¹) was further limited, the Li∥LFP cell with CEE failed within 40 cycles, whereas the cell with ACE showed no capacity loss over 230 cycles at 161.5 mAh g⁻¹ (FIG. 29). Employing 4-V class cathodes is essential for achieving higher energy densities. However, in the absence of a stable CEI, free ether solvent molecules react with the metal oxides to generate acidic species, leading to cathode capacity degradation. The 4.3 V float test suggested greater oxidative instability in CEE than in ACE (FIG. 30). NCA88 half-cells were then cycled for 50 cycles, where ACE and CEE delivered capacities of 186.7 and 94.7 mAh g⁻¹, respectively (FIG. 31). After cycling, CEE exhibited a greater increase in charge transfer impedance compared to ACE (FIG. 32). Similarly, galvanostatic intermittent titration technique identified substantial overpotential growth attributed to ohmic loss in the CEE system, while ACE system demonstrated low overpotentials at different states of discharge (FIG. 33). Analysis of differential capacity (dQ/dV) of the cycled cathodes highlighted a marked decrease in the H2 to H3 phase transition peak intensities, predominantly attributed to the structural collapse of the layered cathode in the CEE system (FIG. 34). The structure of NCA cathodes was visualized using high-resolution transmission electron microscopy (TEM, FIG. 35). The instability of the layered NCA structure against the electrolyte results in phase transition into a rock-salt structure. ACE-cycled NCA cathodes exhibit a thin and uniform rock-salt layer, while CEE-cycled cathodes have a thick resistive layer. Moreover, polycrystalline domains were observed in CEE cycled cathode surfaces, as evidenced by numerous arcs with stretched diffraction spots in Fourier transform images, indicative of the rock-salt structure (FIG. 35a). These findings suggest that the thick, non-conducting CEI and the collapse of the NCA structure collectively contribute to the reduced capacity in the cycled NCA cathodes with CEE. XPS depth profiling analysis was conducted on the NCA88 cathodes to better understand the CEI chemistry after cycling ((FIG. 36). Elemental analysis showed high contents of carbonaceous species originating from PVDF (287.4 and 289.9 eV) in both electrolyte systems (FIG. 37a). The C—C and C—O species, likely derived from ether solvents, were more pronounced in the cycled NCA particles with CEE. The O 1s spectra from the cycled cathodes with ACE exhibited consistent compositions at varying depths with minor SOx and NOx peaks (534 eV), attributable to salt decomposition at the CEI (FIG. 37b). The higher M-O bond signals (530 eV) in the CEE system indicates its inability to effectively passivate the active cathode surface. In contrast, ACE provided sufficient protection to the NCA cathode. Rate capability tests were conducted on NCA88 (4 mAh cm⁻²) half cells with current densities ranging from 0.8 to 20.0 mA cm⁻² (FIG. 38). At a high current density of 20 mA cm⁻², the NCA cells with CEE failed completely, while the cell with ACE maintained a capacity of 70 mAh g⁻¹. Upon returning to a current density of 2 mA cm⁻², the cathode with ACE recovered its original capacity, in contrast to the continued capacity decline in the cell with CEE, which experienced a 36.2% loss post high-rate testing.

### Li Metal and Anode-Free Full Cell Performance

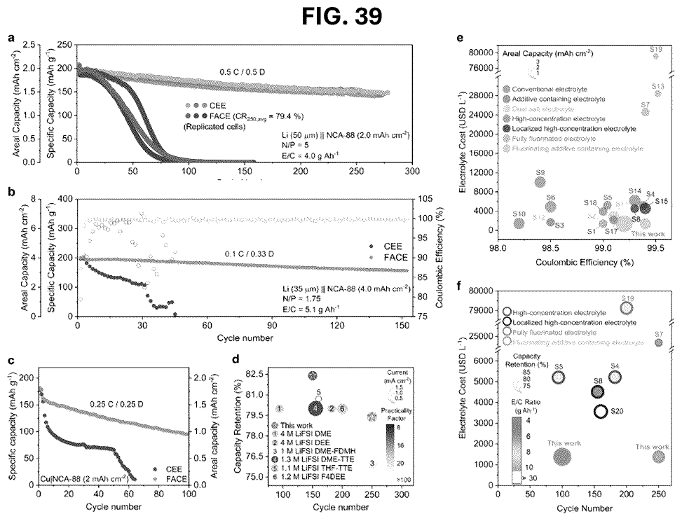

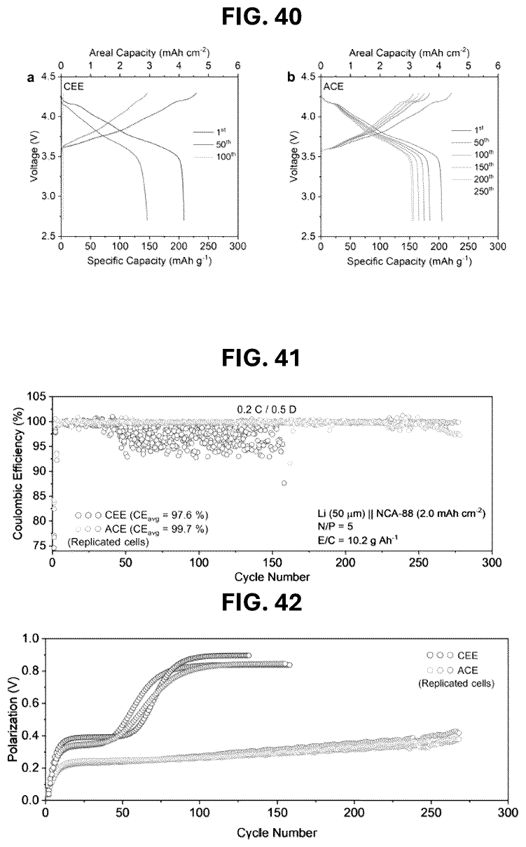

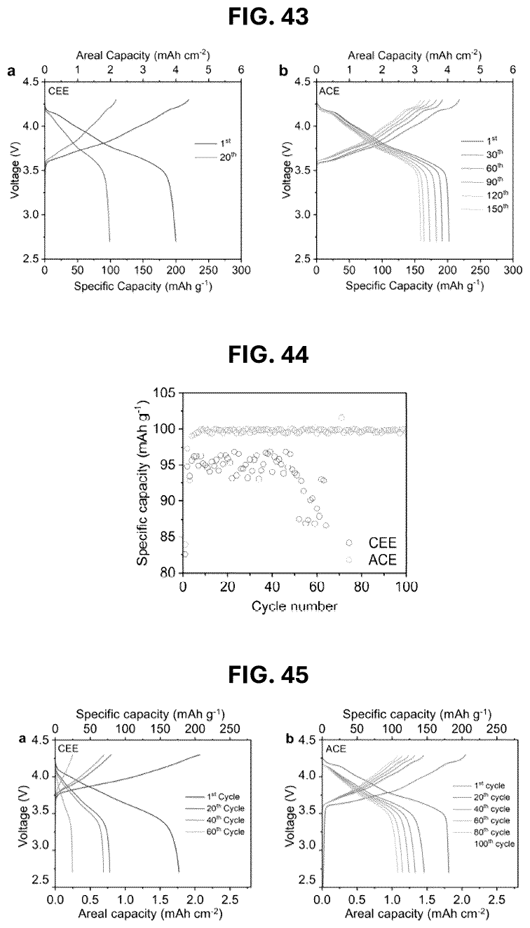

Full cells were fabricated by pairing 50 μm thick LMA with 2 mAh cm⁻² loading NCA88 cathodes (FIG. 39a and FIG. 40). The full cells with CEE failed to deliver any measurable capacity after 100 cycles, with significant CE fluctuations observed throughout the cycling process (FIG. 41). In stark contrast, the cells with ACE maintained an average retention of 80% after 250 cycles. Moreover, a drastic increase in polarization was observed for the cell with CEE compared to stable and steady polarization observed in ACE (FIG. 42). The full cells were evaluated under more practical conditions, consisting of 35 μm thick Li and high-loading cathode (4 mAh cm⁻², N/P ratio=1.75) with low E/C ratios (5.1 g Ah⁻¹) (FIG. 39b). The full cell with CEE rapidly deteriorated, ultimately failing by the 32nd cycle (FIG. 43). Conversely, the ACE-based cell demonstrated robust performance, retaining 82.4% of its initial capacity after 150 cycles (159.3 mAh g⁻¹). The cycling performance of the anode-free (Cu∥NCA-88) cells coupled with 2 mAh cm⁻² NCA-88 cathode under lean electrolyte conditions (5.1 g Ah⁻¹) was then investigated (FIG. 39c). The anode-free full cell employing CEE experienced a sharp initial decrease in capacity along with significant CE fluctuation (FIG. 44). The limited performance of CEE can be ascribed to the linear slope in its voltage profiles, indicative of limited ion transport kinetics within the cell (FIG. 45). In contrast, the cell with ACE demonstrated enhanced performance by achieving 59% capacity retention after 100 cycles. The LMB performance with ACE aligns with state-of-the-art electrolyte design strategies, including WSEs, LHCEs, and FFEs (FIG. 39d). In addition to these technical merits, the manufacturing simplicity and cost-effectiveness of ACE offer a substantial economic advantage over alternative electrolyte design strategies (FIG. 39e and FIG. 39f), as summarized in Tables 1-4 below.

TABLE 1
Physiochemical properties and normalized cost of different solvents and diluents

| | Molecular Weight | Density | Normalized |
|---|---|---|---|
| Solvent/Diluent | (g mol⁻¹) | (kg m [symbol] ) | Price (USD L⁻¹) |
| 1,2-Dimethoxyethane (DME) | 90.12 | 868 | 113 |
| Diethyl ether (DEE) | 74.12 | 713 | 128 |
| Sulfolane (SL) / Tetramethylene sulfone | 120.17 | 1260 | 100.4 |
| (TMS) | | | |
| Thethyl phosphite (TEP) | 166.16 | 969 | 53.25 |
| Dimethyl carbonate (DMC) | 90.08 | 1070 | 101 |
| Bis(2,2,2-trifluoroethyl) ether (BTFE) | 182.06 | 1404 | 22600 |
| 1,1,2,2-Tetrafluoroethyl 2,2,3,3, | 232.07 | 1533 | 2855.2 |
| tetrafluoropropyl ether (TTE) | | | |
| Tris(2,2,2-trifluoroethyl)orthoformate | 310.12 | 1457 | 39800 |
| (TFEO) | | | |
| 2,2,3,3-tetrafluoro-1,4-dimethoxybutane | 190.14 | 980 | 27200 |
| (FDMB) | | | |
| Floroethylene carbonate (FEC) | 106.05 | 1454 | 15860 |
| Methyl (2,2,2-trifluoroethyl) carbonate | 158.08 | 1340 | 9000 |
| (FEMC) | | | |
| Tetrahydrofuran (THF) | 72.11 | 888 | 20.34 |
| 1,1,2,2-Tetrafluorsethyl 2,2,2- | 200.05 | 1487 | 3000 |
| trifluoroethyl ether (HFE) | | | |
| N,N-Dimethylsulfamoyl fluoride (FSA) | 127.14 | 1334 | 58100 |
| N,N- | 177.15 | 1374 | 17900 |
| Dimethyltrifluoromethanesulfomide | | | |
| (DMTMFSA) | | | |
| 1,2-Bis(2,2-difluoroethoxy)ethane | 190.14 | 1240 | 77600 |
| (F4DEE) | | | |
| Ethylene carbonate (EC) | 88.06 | 1321 | 49 |
| 1,3-Dioxolane (DOL) | 74.08 | 1060 | 191 |
| 2-Methyltetrahydrofuran (MeTHF) | 86.13 | 854 | 145 |
| 2,5-Dimethyltetrahydrofuran (DMeTHF) | 100.16 | 833 | 8760 |
| Dimethoxymethane (DMM) | 76.09 | 860 | 216 |

[symbol]

indicates data missing or illegible when filed

TABLE 2
Physiochemical properties and normalized cost of different salts

| | Molecular Weight | Density | Normalized |
|---|---|---|---|
| Solvent/Diluent | (g mol⁻¹) | (kg m⁻³) | Price (USD kg⁻¹) |
| Lithium Bis(fluorosulfonyl)imide (LiSI) | 187.07 | 1052 | 6780 |
| Lithium Hexafluorophosphate (LiPF [symbol] ) | 151.91 | 1500 | 4700 |
| Lithium Bis-trifluoromethanesulfonimide | 287.07 | 1333 | 5180 |
| (LiTFSI) | | | |
| Lithium difluoro(oxalato)borate | 143.77 | 2120 | 4780 |
| (LiDFOB) | | | |
| Lithium nitrate (LiNO₃) | 68.95 | 2380 | 1640 |
| Tetrabutylammonium tetrafluoroborate | 329.27 | 1036 | 2580 |
| (TBATFB) | | | |

[symbol]

indicates data missing or illegible when filed

TABLE 3
Comparison of the state-of-the-art Li||Cu coulombic efficiencies

| | | Li\|\|Cu | Current | | |
|---|---|---|---|---|---|
| Comparison | | Coulombic | density | Capacity | Electrolyte |
| Reference | Electrolyte | Efficiency (%) | (mA cm⁻²) | (mAh cm⁻²) | Cost (USDL⁻¹) |
| S1 | 1M LiFSI DEE⁶ | 99.9 | 0.5 | 1 | 1400.60 |
| S2 | 0.5M LiFSI + 0.5M | 99.0 | 0.25 | 0.625 | 1531.89 |
| | LiTFSI DME:DOL | | | | |
| | (1:1)⁷ | | | | |
| S3 | 1M LiTFSI | 98.5 | 0.5 | 1 | 1673.07 |
| | DME:DOL (1:1) + 3 | | | | |
| | wt % LiNO [symbol] | | | | |
| S4 | 4M LiFSI DEE [symbol] | 99.38 | 0.5 | 1 | 5218.42 |
| S5 | 4M LiFSI DME [symbol] | 99.04 | 0.5 | 1 | 5203.42 |
| S6 | 3.85M LiFSI THF [symbol] | 98.5 | 1 | 2 | 4918.87 |
| S7 | 1M LiFSI | 99.4 | 0.5 | 1 | 24604.59 |
| | DME:FDMH (1:6) [symbol] | | | | |
| S8 | LiFSI:DME:TTE | 99.3 | 0.5 | 1 | 4508.50 |
| | (1:1.2:3) [symbol] | | | | |
| S9 | 1M L2FSI DMeTHF [symbol] | 98.4 | 1 | 1 | 10032.61 |
| S10 | 1M LiFSI MeTHF [symbol] | 98.2 | 1 | 1 | 1417.61 |
| S11 | 1M LiFSI + 1M | 99.1 | 1 | 1 | 2911.78 |
| | LiTFSI DOL:DME | | | | |
| | (1:4) + 0.02M KPBS [symbol] | | | | |
| S12 | 2M LiFSI + 1M | 98.5 | 0.5 | 1 | 4398.96 |
| | LiTFSi DOL:DME | | | | |
| | (1:1) + 3 wt % LiNO [symbol] | | | | |
| S13 | 1M LiFSI FDMB¹⁶ | 99.2 | 0.25 | 0.5 | 28472.61 |
| S14 | 4.86M LiFSI THF [symbol] | 99.3 | 1 | 1 | 6205.20 |
| S15 | 2.43M LiFSI | 99.4 | 1 | 1 | 4530.20 |
| | THF:TTE (1:1)¹⁷ | | | | |
| S16 | 1.5M LiFSI DME¹⁸ | 96.7 | 0.5 | 0.5 | 2021.91 |
| S17 | 1.5M LiFSI DMM [symbol] | 99.1 | 0.5 | 0.5 | 2124.91 |
| S18 | 3M LiFSI DME [symbol] | 99 | 0.5 | 1 | 3930.82 |
| S19 | 1.2M LiFSI F4DEE [symbol] | 99.74 | 0.5 | 1 | 79127.13 |
| Ex. 3 | 1M LiFSI + 0.1M | [symbol] | 1 | 1 | [symbol] |
| | [symbol] THF | | | | |
| Ex. 4 | 1M LiFSI + 0.1M | [symbol] | [symbol] | [symbol] | [symbol] |
| | [symbol] THF | | | | |

[symbol]

indicates data missing or illegible when filed

TABLE 4
Comparison of the state-of-the-art Li metal battery performances

| Comparison | | Cycle | Capacity | E/C | N/P | Practicality | Electrolyte |
|---|---|---|---|---|---|---|---|
| Reference | Electrolyte | number | retention | ratio | ratio | factor | Cost (USDL [symbol] ) |
| 4 | 1M LiFSI DEE [symbol] | 182 | 80 | [symbol] | 2 | 16 | 5218.42 |
| 5 | 0.5M LiFSI + 0.5M | 94 | [symbol] | [symbol] | 2 | 16 | 5203.42 |
| | LiTFSI | | | | | | |
| | DME:DOL (1:1) [symbol] | | | | | | |
| 7 | [symbol] M LiFSI | 250 | 76 | 10 | 2 | 20 | 24604.59 |
| | DME:FDMH | | | | | | |
| | ( [symbol] ) [symbol] | | | | | | |
| 8 | LiFSI:DME:TTE | 155 | [symbol] | 3 | 2.48 | 7.44 | 4508.50 |
| | (1:1.2:3) [symbol] | | | | | | |
| 19 | 1.2M LiFSI | 200 | [symbol] | [symbol] | 2.125 | 17 | 79127.1 [symbol] |
| | F4DEE [symbol] | | | | | | |
| 20 | LiFSI:THF:TTE | 160 | 80.7 | [symbol] 7.5 | 45 | 1687. [symbol] | 3560.83 |
| | (1:263.2)2] | | | | | | |
| Ex. 5 | [symbol] | [symbol] | [symbol] | [symbol] | [symbol] | [symbol] | [symbol] |
| Ex. 6 | [symbol] | [symbol] | [symbol] | [symbol] | [symbol] | [symbol] | [symbol] |

[symbol]

indicates data missing or illegible when filed

### Experiment 2

The method developed the electrolyte with augmented interfacial stability, referred to as tetrabutylammonium tetrafluoroborate (TBATFB) electrolytes, specifically targeting the susceptibilities of the Li metal anode and high-voltage cathodes through additive engineering. By integrating the TBATFB additive, the exemplary method address the challenges intrinsic to each electrode. enabling the stable and cost-effective operation of high-energy Li metal batteries.

For the baseline electrolyte, 1M lithium bis(fluorosulfonyl)imide (LiFSI) was dissolved in anhydrous THF (Comparative Example 2). To investigate the additives, 0.1 M (Example 7), 0.5 M (Example 8), and 1.0 M (Example 9) of TBATFB were introduced to the 1 M LiFSI/THF electrolytes and were denoted as 0.1 M TBATFB, 0.5 M TBATFB, and 1.0 M TBATFB, respectively.

### Examining the Electrochemical Properties of the TBATFB Electrolyte

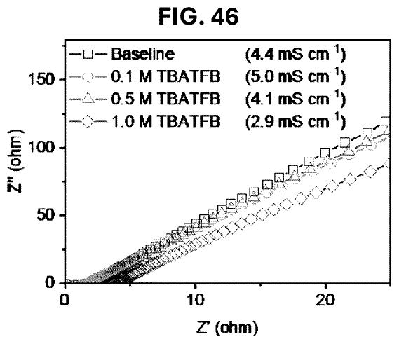

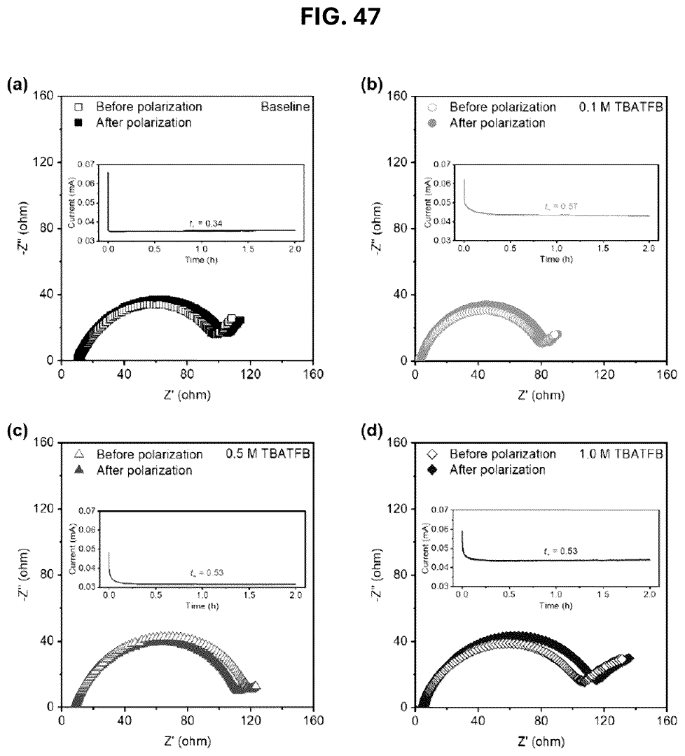

Ionic conductivity in electrolytes is a foundational characteristic in the performance of batteries by enabling efficient charge transport. FIG. 46 shows the ionic conductivity measurements of the electrolytes. The 0.1 M TBATFB exhibited the highest conductivity (5.0 mS cm⁻¹), followed by the baseline electrolyte (4.4 mS cm⁻¹), 0.5 M TBATFB 24 (4.1 mS cm⁻¹), and 1.0 M TBATFB (2.9 mS cm⁻¹). The 0.5 M and 1.0 M 25 TBATFB electrolytes showed lower ionic conductivity, most likely due to increased viscosity of the electrolyte.

Next, the transference number (t+) was assessed to determine the efficiency of Li-ion transport (FIG. 37). The baseline electrolyte exhibited a low t+ value of 0.34, which is the typical value of conventional electrolytes. In comparison, the addition of TBATFB increases the t+ value to 0.57, 0.53, and 0.53 for 0.1 M, 0.5 M, and 1.0 M TBATFB. The t+ value of 0.1 M TBATFB is slightly higher than 0.5 M and 1.0 M TBATFB, mostly due to the increased ionic conductivity of the electrolyte resulting from the reduced viscosity. The enhanced electrochemical kinetics at the electrode/electrolyte interface, where dynamic redox reactions occur, are facilitated by the high ionic conductivity and t+ values, facilitate in improving the performance of the Li metal batteries.

### Investigating Li Reversibility and Reductive Stability

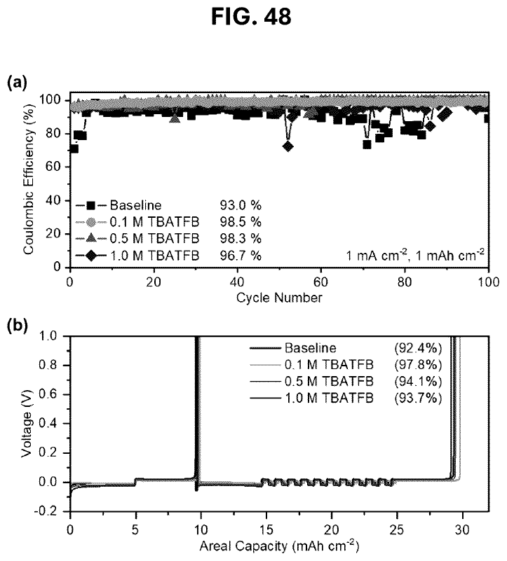

The stability of Li metal batteries relies on the compatibility of electrolytes and Li metal. The Li reversibility was measured by evaluating the coulombic efficiency of Li∥Cu asymmetric cell at 1 mA cm⁻² and 1 mAh cm⁻² (FIG. 48a). The baseline electrolyte exhibited unstable Li plating and stripping behavior with a low average coulombic efficiencies (CE) of 93.0%. In contrast, the addition of the TBATFB salt showed a drastic increase in average CE (98.5% for 0.1 M TBATFB, 98.3% for 0.5 M TBATFB, and 96.7% for 1.0 M TBATFB). To identify the Li loss without the effect of Cu substrate, Aurbach protocol was performed at 0.5 mA cm⁻² and 0.5 mAh cm⁻² with a reservoir capacity of 5.0 mAh cm⁻² (FIG. 48b). The baseline electrolyte maintained a low CE at 92.4%. 0.5 M TBATFB and 1.0 TBATFB showed increased CE of 94.1% and 93.7%, respectively. In stark contrast, 0.1 M TBATFB demonstrated higher reversibility with CE of 97.8%.

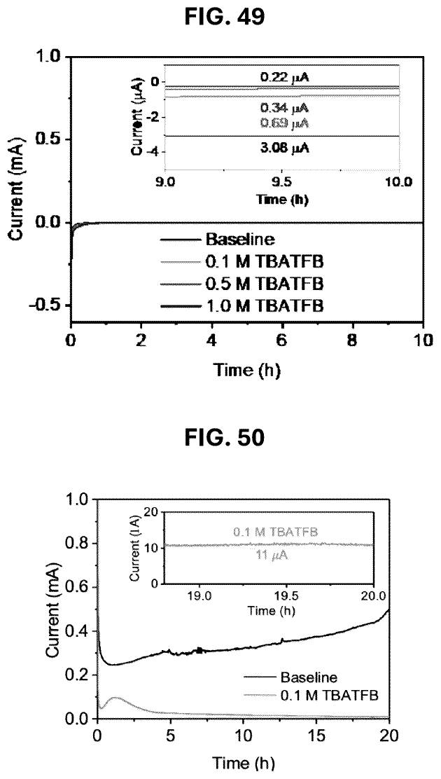

To obtain greater insights into the solid-electrolyte interface (SEI) stability, the passivation stability was measured. The passivation stability test was conducted by measuring the leakage current while maintaining 0.0 V (vs. Li/Li+) in a Li∥Cu asymmetric cell for 10 hours (FIG. 49). The findings reveal that the baseline electrolyte exhibits a considerably higher leakage current (3.08 μA) compared to electrolytes containing TBATFB (0.22-0.69 μA), suggesting that the SEI is less effective at fully passivating the vulnerable Li metal anode. Additionally, the stability of the SEI improves with increasing TBATFB content, indicating that TBATFB actively contributes to the initial SEI formation process. Based on these results, the TBATFB can effectively enhance the interfacial stability of the Li metal anode with improved bulk electrolyte performance.

### Determining Oxidative Stability

Single crystal LiNi_{0.88}Co_{0.09}Al_{0.03}O₂(NCA-88) was selected as the high-voltage cathode to determine the oxidative stability of the modified electrolyte. Floating test was conducted to measure the leakage current when the cell was held at a constant voltage of 4.3 V vs. Li/Li+ for 20 hours (FIG. 50). The baseline electrolyte was incapable of maintaining stability at the fixed potential, leading to an steadily increasing leakage current with time. In comparison, the 0.1 M TBATFB electrolyte exhibited leakage current, indicative of less side reactions occurring at the cathode-electrolyte interphase (CEI). The engineered electrolyte reached a minimum of 11 μA, which reflects the fully passivated cathode surface.

### Assigning the Electrochemical Performance of the Li Metal Batteries Tested Under Stringent Conditions

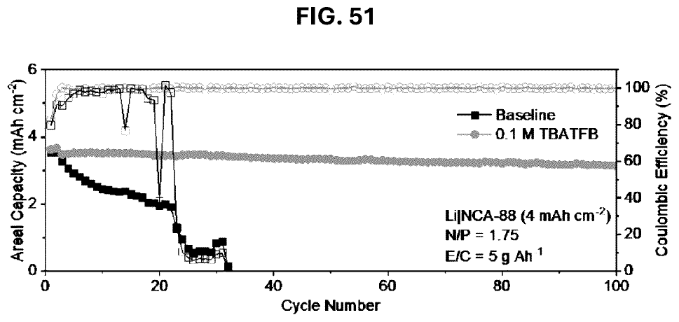

To maximize the full cell energy density, thin Li (35 μm) was paired with high-loading cathode (20 mg cm⁻²), alongside low N/P (1.75) and E/C (5 g Ah⁻¹) ratios (FIG. 51). The baseline electrolyte showed a steep decline in capacity, marking 50% capacity retention within the first 20 cycles, before the cell failed completely within the next 10 cycles. In comparison, the 0.1 M TBATFB electrolyte was able to deliver improved cycling stability, achieving 91% capacity retention after 100 cycles.

The above experiments demonstrate the effectiveness of electrolyte solutions according to disclosed aspects in enhancing the stability of electrode-electrolyte interphases within ether-based electrolytes. The results show that the incorporation of TBATFB salt into ether solvent electrolytes significantly improves various key parameters, including CE, LMA passivation stability, exchange current density, and Li+ ion selectivity, while preserving the high ionic conductivity innate to ether electrolytes. The endurance and stability conferred by electrolyte solutions according to disclosed aspects extended the cycle life for higher-performance LMBs under practical conditions. Furthermore, these results suggest that strategies employing the electrolyte solutions according to disclosed aspects offer a cost-effective solution for stabilizing electrode-electrolyte interphases without the need to tailor the electrolyte solvation structure. This strategy effectively addresses several fundamental interfacial challenges and performance limitations associated with secondary batteries.

It will be understood by those of ordinary skill in the art that aspects of the present disclosure may be performed within a wide equivalent range of parameters without affecting the scope of the disclosure described herein. All publications, patent applications and patents disclosed herein are incorporated by reference in their entirety.

What is claimed is:

1. An electrolyte composition for a secondary battery, the electrolyte composition comprising:
an electrolyte compound;
a quaternary ammonium fluoride-containing compound; and
a solvent.

2. The electrolyte composition according to claim 1, wherein the solvent comprises an ether compound.

3. The electrolyte composition according to claim 2, wherein the ether compound comprises at least one selected from the group consisting of tetrahydrofuran (THF), ethylene carbonate (EC), diethyl ether (DEE), 1,3-dioxolane (DOL), 1,2-dimethoxyethane (DME), cyclohexyl ether, tetraethylene glycol dimethyl ether (TEGDME), 1,1,2,2-tetrafluorethyl 2,2,3,3-tetrafluoropropylether (TTTE), fluorinated 1,6-dimethoxyhexane (FDMH), 1,2-bis(2,2-difluoroethoxy)-ethane (F4DEE), 2-methyltetrahydrofuran, dimethyl tetrahydrofuran, dimethoxytetrahydrofuran, ethoxytetrahydrofuran, dihydropyran, tetrahydropyran, furan, and 2-methylfuran.

4. The electrolyte composition according to claim 3, wherein the ether compound comprises tetrahydrofuran (THF).

5. The electrolyte composition according to claim 1, wherein the electrolyte compound comprises at least one selected from the group consisting of lithium bis(fluorosulfonyl) imide (LiFSI), lithium bis(trifluoromethanesulfonyl)imide (LTFSI), LiPF₆, LiAsF₆, LiBF₄, LiCF₃SO₃, and LiCliO₄.

6. The electrolyte composition according to claim 5, wherein the electrolyte compound comprises lithium bis(fluorosulfonyl)imide (LiFSI).

7. The electrolyte composition according to claim 1, wherein the quaternary ammonium fluoride-containing compound comprises tetrabutylammonium tetrafluoroborate (TBATFB).

8. The electrolyte composition according to claim 1, wherein the electrolyte compound and the quaternary ammonium fluoride-containing compound are comprised in the electrolyte composition at a molar ratio in a range of 10:0.01 to 0.1:5.

9. The electrolyte composition according to claim 1, wherein the electrolyte compound and the quaternary ammonium fluoride-containing compound are comprised in the electrolyte composition at a molar ratio in a range of 1:0.1 to 1:1.

10. A secondary battery comprising the electrolyte composition according to claim 1.

11. A secondary battery comprising:
a positive electrode;
a negative electrode; and
an electrolyte composition comprising lithium bis(fluorosulfonyl)imide (LiFSI), tetrabutylammonium tetrafluoroborate (TBATFB), and tetrahydrofuran (THF).

12. The secondary battery according to claim 11, wherein the lithium bis(fluorosulfonyl)imide (LiFSI) and the tetrabutylammonium tetrafluoroborate (TBATFB) are comprised in the electrolyte composition at a molar ratio in a range of 1:0.1 to 1:1.

13. The secondary battery according to claim 11, wherein the secondary battery has a columbic efficiency of greater than 95% over at least 200 cycles.

14. The secondary battery according to claim 11, wherein the secondary battery has a specific capacity of greater than 100 mAh/g for at least 100 cycles at a charge/discharge rate in a range of C/5 to 1C.

15. The secondary battery according to claim 11, wherein the secondary battery has a capacity retention of greater than 90% for at least 500 cycles at a charge/discharge rate in a range of C/5 to 1C.

16. The secondary battery according to claim 11, wherein the positive electrode is configured to intercalate Li+ ions or Na+ ions.

17. An electric vehicle comprising the secondary battery according to claim 11.

18. A method of preparing a secondary battery, the method comprising:
forming an electrode assembly comprising a positive electrode and a negative electrode; and
injecting into the electrode assembly an electrolyte composition comprising:
an electrolyte compound;
a quaternary ammonium fluoride-containing compound; and
a solvent.

19. The method according to claim 18, wherein the electrolyte compound and the quaternary ammonium fluoride-containing compound are comprised in the electrolyte composition at a molar ratio in a range of 10:0.01 to 0.1:5.

20. The method according to claim 18, wherein the electrolyte compound comprises lithium bis(fluorosulfonyl)imide (LiFSI),
the quaternary ammonium fluoride-containing compound comprises tetrabutylammonium tetrafluoroborate (TBATFB), and
the solvent comprises tetrahydrofuran (THF).
